(19) United States
(12) Patent Application Publication
(10) Pub. No.: US 2024/0262453 A1
(43) Pub. Date: Aug. 8, 2024

(54) AERODYNAMIC PROFILE

(71) Applicant: RUTTEN ENERGY SNC, Blégny (BE)

(72) Inventor: Jean Rutten, Blégny (BE)

(21) Appl. No.: 18/443,881

(22) Filed: Feb. 16, 2024

Related U.S. Application Data
(63) Continuation-in-part of application No. PCT/IB2022/057734, filed on Aug. 18, 2022.

(30) Foreign Application Priority Data
Aug. 19, 2021 (BE) 2021/0057

(51) Int. Cl. B62K 19/48; B62K 19/02

(52) U.S. Cl. CPC B62K 19/48; B62K 19/02

(57) ABSTRACT

Aerodynamic symmetrical profiled element (1) for a wheeled vehicle (V) having, in cross section perpendicular to the plane of symmetry (12), at least 90% of the central part of a sage leaf profile with at least 5 arcs of circle, with a ratio between maximum spacing (E) measured perpendicular to the plane of symmetry (12) and cord (C) measured in the plane of symmetry (12) comprised between 0.1 and 0.3. Said profiled element is adapted to create a force always directed towards the leading edge (16) of the profiled element for all the resultants combining the speed of the wind and the forward speed of the vehicle.

The present application is a Continuation-in-Part of PCT Application No. PCT/IB2022/057734, filed on Aug. 18, 2022, and published on Feb. 23, 2023, under number WO 2023/021449, and claiming the priority benefit of Belgian Patent Application No. BE2021/0057, filed on Aug. 19, 2021, the disclosures of which are incorporated herein by reference in their entireties.

### Field of Invention

The invention relates to an aerodynamically symmetrical profiled element (1) for a wheeled vehicle (V) adapted to create a force always directed towards the leading or front edge of the profile for all the resultants combining the speed of the wind and the forward speed of the vehicle, facilitating the forward movement of the vehicle, especially slow moving vehicles, moving at a speed of less than 100 km/h, such as bicycles, advantageously bicycles with electric assistance. Said profiled element has, in cross section perpendicular to the plane of symmetry (12), a pattern following at least 90% of the central part of a profile with at least 5 arcs of circles, with a ratio between the maximum spacing (E) measured perpendicular to the plane of symmetry (12) and the cord (C) measured in the plane of symmetry (12) between 0.1 and 0.3.

### The State of the Art

In the present specification, by slow moving vehicles, we advantageously mean bicycles, power-assisted bicycles, motorized bicycles, power-assisted scooters, etc.

Many bicycle manufacturers have an interest in finding solutions to improve the performance of cyclists. Some manufacturers have thus searched ways to reduce the weight of the frame of their bicycles as much as possible, sometimes to the detriment of their robustness.

Other manufacturers have been interested in improving the aerodynamics of the bike and in particular the “rider and bike” crew. These manufacturers have carried out numerous tests in the aerodynamic tunnel, to try to find the optimal aerodynamics, in particular with headwinds.

As examples of research undertaken to improve the aerodynamics of a bicycle, reference may be made to:

Timothy N. Crouch et al, “Riding against the wind: a review of competition cycling aerodynamics”, Sports Eng (2017) 20:81-110, (this article concludes that future research is needed to improve cyclist performance—in 2017, improving the performance of a cyclist was still relevant);

Malizia Fabio et al, “Bicycle aerodynamics: History, state-of-the-art and future perspectives”, Journal of Wind Engineering & Industrial Aerodynamics 200, 2020 (this study also concludes that the complexity of the aerodynamics of a bicycle encounters many difficulties and leaves an area for research and innovation to improve aerodynamics.); and

Schwabb A. et al, “Some Effects of Crosswind on the Lateral Dynamics of a Bicycle”, ISEA Proceedings 2018, 2, 218 (this study analyses the effect of a crosswind on the stability of a cyclist).

All these studies show that, despite that many improvements have already been made to bicycles, the person skilled in the art is still looking for innovations in the context of aerodynamics for bicycles, for improving the performance of the cyclist.

Research has also been conducted to minimise the drag effects for bicycle (see for example Belgian patent BE 2008/0357 (publication number BE1018201) and its US equivalent US2009/0322053; as well as further example US application US2010/0253038). US patent U.S. Pat. No. 8,556,208 describes a profile for a bicycle frame in the shape of an aircraft wing. U.S. Pat. No. 7,322,592 describes an aerodynamic cover for a bicycle. International patent application WO2014/191417 describes a complete fairing for a bicycle.

WO2021/053352 discloses a bicycle comprising a pair of front forks, each fork extending downwardly and substantially parallel to each other from a crown, the forks widely spaced apart from each other, with the front wheel mounted there between. The aim of said bicycle is to reduce the drag when a rider is positioned in a normal riding position.

US2020/039601 discloses a racing bicycle comprising a frame provided with a head tube, a top tube and a fork connectable on one side to the head tube and on the other side to a wheel of the bicycle; in the fork one or more apertures are made for the passage of the air, made between the external surface of the wheel and the top of the head tube; the one or more apertures are configured to allow at least part of the stream of air that hits the bicycle to pass in a central zone of the bicycle and in proximity to the frame; the top tube is positioned above the one or more apertures in order to leave the central zone free, and therefore not interfere with the stream of air passing in the central zone and below the top tube.

U.S. Pat. No. 5,221,102 discloses a bicycle frame which includes a plurality of structurally supporting tubes which are constructed in an aerodynamic shape resembling a teardrop. Each of the aerodynamic tubes have a major axis which is approximately three and one half times greater than the length of the minor axis. Each of the aerodynamic tubes are extruded incorporating an x-shaped cross brace the entire length of the tube within the internal chamber of the tube.

Applicant is also aware of a series of frames marketed under various brands or trademarks, namely Pinarello, Bianchi, Cervelo, Scott, BMC, Jamis, Trek, Ridley Bikes, Giant, Eddy Merckx, Gazelle, Peugeot, Mercedes.

All the frames described in these documents and/or marketed do not have a profile with a cross section in the shape of a sage leaf with 5 tangent radii.

### Brief Description of the Invention

After research and numerous tests, Applicant has found that by using very specific profiles having the shape of a sage leaf with 5 tangent arcs or segments of circles, it has been possible to reduce, or even completely cancel the drag, but in addition, in the event of a side or inclined wind direction with respect to the travel direction of the bicycle, to generate a positive force in the direction of advancement of the bicycle, even in the event of a headwind or inclined headwind. This effect is quite surprising and is not described, nor suggested in the state of the art.

Applicant has thus noticed following a series of tests, that by using a bicycle frame with a particular sage leaf profile, it was possible with winds of 10 km/h to 50 km/h with an angle of incidence from 10° to 25° in relation to the travel or movement direction of the bicycle to generate a motor effect due to the wind on the particular profile of the frame of approximately 5N to 10N, or even more, which then results in a contribution of power from 30W to 60W depending on the forward speed of the bike and the wind speed and its angle of incidence. This beneficial effect was not obtained by using commercial bicycle frames. Even more surprisingly, the applicant noticed during tests with winds of 10 to 50 km/h, that a motor effect was always obtained for any angle of incidence of the wind, that is to say at the times with a crosswind, an orthogonal wind, a tailwind and a headwind, this even with a low incidence in relation to the travel or movement direction of the vehicle. The particular sage leaf profile has also proven to have a reduced friction loss in all winds, including wind speeds of 10 to 80 km/h.

Tests carried out by Applicant have shown that when one deviates from this sage leaf profile, there is no longer any marked motor effect by side wind, for example with a head wind with an angle of incidence of 15° or less.

The motor effect obtained by the invention is particularly interesting for electrically assisted bicycles, as it saves Wh (Watt-hour) from the battery, thus allowing a reduction in the size of the battery for assistance of movement over a given distance, a reduction in the total weight of the bicycle with the battery, or an electric assistance of movement for the bicycle over a greater distance. Reducing the size of the battery also makes it possible to better integrate it into the frame of the bicycle or a compartment thereof, and therefore to better protect it from bad weather and theft or other acts of vandalism.

The invention thus relates to an aerodynamically symmetrical profiled element (1) for a wheeled vehicle (V) having, in cross section perpendicular to the plane of symmetry (12), at least 90% of the central part of a profile with at least 5 arcs of circles, called sage leaf, with a ratio between the maximum spacing (E) measured perpendicular to the plane of symmetry (12) and the cord (C) measured in the plane of symmetry (12) between 0.1 and 0.3, advantageously between 0.1 and 0.25, preferably between 0.2 and 0.25. Said profile is adapted to create a force always directed towards the leading or front edge of the profile for all the resultants combining the speed of the wind and the forward speed of the vehicle, facilitating the forward movement of the vehicle.

The subject of the invention is thus an aerodynamic symmetrical profiled element for a wheeled vehicle (V) adapted to move at least on a surface defining a horizontal rolling plane at a speed of less than 100 km/h, said profiled element (1,2,3,4) having a plane of symmetry (12) and a curved front end (10) with at least one leading edge, wherein in position of the profiled element with the plane of symmetry (12) located in a vertical plane with the wheeled vehicle rolling on the horizontal rolling plane, said profiled element (1,2,3,4) has the curved front end (10), a rear end (11), and on either side of said plane of symmetry (12), a curved outer face (13,14), said curved outer faces (13,14) defining in each cross section plane perpendicular to the plane of symmetry (12) and parallel to said horizontal rolling plane (H), a cross-section aerodynamic profile (15),

whereby at least for a part of the profiled element (1,2,3,4), the said cross- section aerodynamic profile (15) has at least 90% of a central part of a sage leaf profile with a ratio [maximum spacing (E)/maximum cord (C)] comprised between 0.1 and 0.3, advantageously between 0.1 and 0.25, preferably between 0.2 and 0.25, whereby the maximum spacing (E) is measured perpendicular to the plane of symmetry (12), while the maximum cord (C) measured in the plane of symmetry (12).

According to the profiled element of the invention, the profiled element is characterised in that:
said sage leaf profile (15) with a ratio [maximum spacing (E)/maximum cord (C)] comprised between 0.1 and 0.3, advantageously comprised between 0.1 and 0.25, preferably between 0.2 and 0.25, comprises two symmetrical curved shapes (13,14) with respect to said plane of symmetry (12) of the profiled element, each curved shape (13,14) of said two symmetrical curved shapes (13,14) extending between a first front point (16) and a second rear point (17), said first front point and second rear point (16,17) extending along an axis of symmetry (AX) which extends within the plane of symmetry (12). Said axis of symmetry (AX) is advantageously parallel to said rolling plane (H).
each curved shape (13,14) of said two symmetrical curved shapes (13,14) of said sage leaf profile is defined substantially by 5 to 10 successive arcs of circles (A1 of circle C1, A2 of circle C2, A3 of circle C3, A4 of circle C4, A5 of circle C5), said successive arc of circles being each characterised by a centre of curvature and a radius of curvature, whereby said successive arcs of circles (A1, A2, A3,A4,A5) are interior tangent two by two with increasing radius of curvature (R1,R2,R3,R4,R5) from a minimum radius of curvature (R1) for a curved part in the vicinity of the first front point (16) and a maximum radius of curvature (R5) for a curved part in the vicinity of the second rear point (17), whereby the arc of circle (A1) of the curved part in the vicinity of the first front point (16) is passing through the first front point (16), has its centre of curvature (CC1) located along said axis of symmetry (AX) of the plane of symmetry (12) and has its radius of curvature corresponding to a first radius of curvature (R1) comprised between 0.2 and 0.3 times the maximum spacing (E) of the sage leaf profile,
each curved shape of the said cross-section aerodynamic profile (15) of the profiled element (1,2,3,4) follows substantially at least 95% of a sage leaf profile pattern with two symmetrical curved patterns, each symmetrical curved pattern of said two symmetrical curved patterns being defined by five successive arcs of circles, which are:
   a first arc of circle (A1) with a first radius of curvature (R1);
   a second arc of circle (A2) with a second radius of curvature (R2) comprised between 1.8 and 2.2 times the first radius of curvature (R1);
   a third arc of circle (A3) with a third radius of curvature (R3) comprised between 8.5 and 10.5 times the first radius of curvature (R1);
   a fourth arc of circle (A4) with a fourth radius of curvature (R4) comprised between 25 and 30 times the first radius of curvature (R1); and
   a fifth arc of circle (A5) with a fifth radius of curvature (R5) comprised between 50 and 70 times the first radius of curvature (R1).

According to advantageous embodiments, the profiled element of the invention has one or more of the following characteristics:
for each symmetrical curved pattern of the sage leaf profile pattern defined by the five successive arcs of circles, the circles defining the said 5 arcs of circles are inner tangent circles two by two, the first circle (C1) defining the first arc of a circle (A1) being inner tangent to the second circle (C2) at a first point of tangency, the second circle (C2) defining the second arc of a circle (A2) being interior tangent to the third circle (C3) at a second point of tangency, the third circle (C3) defining the third arc of a circle (A3) being interior tangent to the fourth circle (C4) at a third point of tangency, and the fourth circle (C4) defining the fourth arc of a circle (A4) being interior tangent to the fifth circle (C5) defining the fifth arc of a circle (A5) at a fourth point of tangency, said first point of tangency, said second point of tangency, said third point of tangency and said fourth point of tangency defining a series of distinct points of tangency (T1,T2,T3,T4). And/or
the sage leaf profile has a ratio [maximum spacing (E)/maximum cord (C)] comprised between 0.1 and 0.25. And/or
each curved shape (13,14) of said two symmetrical curved shapes (13,14) of said sage leaf profile is defined substantially by a number of successive arcs of circles selected from the group consisting of 5, 6 and 7. And/or
each curved shape of said two symmetrical curved shapes (13,14) of said sage leaf profile is defined substantially by 5 successive arcs of circles. And/or
at least for a part of the profiled element (1,2,3,4), the said cross-section aerodynamic profile (15) has at least 95% of said central part of said sage leaf profile, the ratio [maximum spacing (E)/maximum cord (C) ] of which being comprised between 0.2 and 0.25. And/or
the profiled element (1,2,3,4) is at least partially hollow. And/or
with respect to the plane of symmetry (12) of the profiled element (1,2,3,4) located in a vertical plane for the wheeled vehicle (V) resting on the horizontal rolling plane (H), the profiled element (1,2,3,4) has at least:
   a first portion of the profiled element (3) extending between, on the one hand, a lower cross-section plane (P1) of the profiled element (3), said lower cross-section plane (P1) being parallel to the horizontal rolling plane (H), and, on the other hand, a first intermediate cross-section plane (P2) of the profiled element (3) parallel to the lower cross-section plane (P1), and
   a second portion of the profiled element (3) extending between, on the one hand, a second intermediate cross-section plane parallel to the lower cross-section plane (P1), said second intermediate cross-section plane being selected from the group consisting of the first intermediate cross- section plane (P2) and a different intermediate cross-section plane different from the first intermediate cross-section plane (P2), and, on the other hand, an upper cross-section plane (P3) of the profiled element (3) parallel to the lower cross-section plane (P1),

The first intermediate plane (P2) extends between the lower cross-section plane (P1) and the upper cross-section plane (P3), while the second intermediate cross-section plane is a cross-section plane selected from the group consisting of the first intermediate cross-section plane (P2) and a cross-section plane extending between the first intermediate cross-section plane (P2) and the upper cross-section plane (P3).

Said first portion of the profiled element (3) has, for each cross-section plane parallel to the lower cross-section plane (P1) between the lower cross-section plane (P1) and the first intermediate cross-section plane (P2), a first cross-section aerodynamic profile following substantially at least 95% of a first substantially constant sage leaf profile pattern defined by a cord (C) measured in the vertical plane of symmetry (12) and a maximum spacing (E) measured perpendicular to the vertical plane of symmetry (12), such that the ratio [said maximum spacing (E)/said maximum cord (C)] of said first substantially constant sage leaf profile pattern is comprised between 0.1 and 0.3, advantageously between 0. and 0.25, preferably between 0.2 and 0.25.

The second portion of the profiled element (3) has, for each cross-section plane parallel to the lower cross-section plane (P1) and extending between the second intermediate cross-section plane and the upper cross-section plane (P3), a variable cross-section aerodynamic profile following substantially at least 95% of a variable sage leaf profile pattern that varies continuously between
a maximum sage leaf profile pattern defined by a maximum cord (C) measured in the vertical plane of symmetry (12) and a maximum spacing (E) measured perpendicular to the plane of symmetry (12), and
a minimum sage leaf profile pattern defined by a minimum cord (C′) measured in the vertical plane of symmetry (12) less than the maximum cord (C) and a minimum spacing (E′) less than the maximum spacing (E),
   whereby each variable sage leaf profile pattern has a ratio [spacing (E,E′) measured perpendicular to the plane of symmetry/cord (C,C′) measured in the plane of symmetry (12)] comprised between 0.1 and 0.3, advantageously between 0.1 and 0.25, preferably between 0.2 and 0.25. And/or
the first substantially constant sage leaf profile pattern and the variable sage leaf profile pattern have a ratio [spacing measured perpendicular to the plane of symmetry/cord measured in the plane of symmetry] comprised between 0.1 and 0.25. And/or
the first substantially constant sage leaf profile pattern and the variable sage leaf profile pattern have a ratio [spacing measured perpendicular to the plane of symmetry/cord measured in the plane of symmetry ] comprised between 0.2 and 0.25. And/or
the wheeled vehicle (V) in an upright position with wheels resting on a horizontal plane (H), the aerodynamic symmetrical profiled element has:
   a vertical plane of symmetry (12) and
   at least one portion extending between a first horizontal plane perpendicular to said vertical plane of symmetry (12) and a second horizontal plane perpendicular to said vertical plane of symmetry (12), said portion being characterised by a substantially constant horizontal cross-section aerodynamic profile (15) substantially following a constant sage leaf profile pattern defined with a determined length for the cord (C) measured in the vertical plane of symmetry (12) and a determined spacing (E) measured perpendicular to the vertical plane (12). And/or
a combination of two or more of two of these features. The invention relates also to a frame (20) of a wheeled vehicle (V) adapted to move at least on a surface defining a horizontal rolling plane at a speed of less than 100 km/h, whereby said frame is adapted to support at least one front wheel (21) and one rear wheel (22), said frame (20) comprising at least one frame part selected from the group consisting of
(a) a saddle profile (23) with a lower end (23A) and an upper end (23B) adapted to support a saddle post (24),
(b) a steering profile (25) adapted to receive a steering stem (26) associated at least with a fork (27) for at least one front wheel (21), and with a handlebar (28), and
(c) a diagonal profile (1) connecting the lower end (23A) of the saddle profile (23) to the steering profile (25),
(d) a substantially horizontal profile (2) connecting the upper end (23B) of the saddle profile (23) to said steering profile (25), and
(e) an integrated frame part integrating at least partly at least two elements selected form the group consisting of the saddle profile (23), the steering profile (25), the diagonal profile (1) and the substantially horizontal profile (2). The frame of the invention is essentially characterised in that at least one frame part is an aerodynamic symmetrical profiled element of the invention as disclosed here above.

The frame of the invention is essentially characterised in that:
said at least one frame part is an aerodynamic symmetrical profiled element (1,2,23,25) having a plane of symmetry (12) and a curved front end (10) with at least one leading edge, wherein in position of the profiled element with the plane of symmetry (12) located in a vertical plane with the wheeled vehicle rolling on the horizontal rolling plane, said profiled element (1,2,23,25) has the curved front end (10), a rear end (11), and on either side of said plane of symmetry (12), a curved outer face (13,14), said curved outer faces (13,14) defining in each cross section plane perpendicular to the plane of symmetry (12) and parallel to said horizontal rolling plane (H), a cross-section aerodynamic profile (15),
at least for a part of the profiled element (1,2,23,25), the said cross-section aerodynamic profile (15) has at least 90% of a central part of a sage leaf profile with a ratio [maximum spacing (E)/maximum cord (C)] comprised between 0.1 and 0.3, advantageously between 0.1 and 0.25, preferably between 0.2 and 0.25, whereby the maximum spacing (E) is measured perpendicular to the plane of symmetry (12), while the maximum cord (C) measured in the plane of symmetry (12);
said sage leaf profile (15) with a ratio [maximum spacing (E)/maximum cord (C)] comprised between 0.1 and 0.3, advantageously between 0.1 and 0.25, preferably between 0.2 and 0.25, comprises two symmetrical curved shapes (13 ,14) with respect to said plane of symmetry (12) of the profiled element, each curved shape (13,14) of said two symmetrical curved shapes (13,14) extending between a first front point (16) and a second rear point (17), said first front point and second rear point (16,17) extending along an axis of symmetry (AX) which extends within the plane of symmetry (12),
each curved shape (13,14) of said two symmetrical curved shapes (13,14) of said sage leaf profile is defined substantially by 5 to 10 successive arcs of circles (A1 of circle C1, A2 of circle C2, A3 of circle C3, A4 of circle C4, A5 of circle C5), said successive arcs of circles being each characterised by a centre of curvature and a radius of curvature, whereby said successive arcs of circles (A1, A2, A3,A4,A5) are interior tangent two by two with increasing radius of curvature (R1,R2,R3,R4,R5) from a minimum radius of curvature (R1) for a curved part in the vicinity of the first front point (16) and a maximum radius of curvature (R5) for a curved part in the vicinity of the second rear point (17), whereby the arc of circle (A1) of the curved part in the vicinity of the first front point (16) is passing through the first front point (16), has its centre of curvature (CC1) located along said axis of symmetry (AX) of the plane of symmetry (12) and has its radius of curvature corresponding to a first radius of curvature (R1) comprised between 0.2 and 0.3 times the maximum spacing (E) of the sage leaf profile,
each curved shape of the said cross-section aerodynamic profile (15) of the profiled element (1,2,23,25) follows substantially at least 95% of a sage leaf profile pattern with two symmetrical curved patterns, each symmetrical curved pattern of said two symmetrical curved patterns being defined by five successive arcs of circles, which are:
   a first arc of circle (A1) with a first radius of curvature (R1);
   a second arc of circle (A2) with a second radius of curvature (R2) comprised between 1.8 and 2.2 times the first radius of curvature (R1);
   a third arc of circle (A3) with a third radius of curvature (R3) comprised between 8.5 and 10.5 times the first radius of curvature (R1);
   a fourth arc of circle (A4) with a fourth radius of curvature (R4) comprised between 25 and 30 times the first radius of curvature (R1); and
   a fifth arc of circle (A5) with a fifth radius of curvature (R5) comprised between 50 and 70 times the first radius of curvature (R1).

The frame of the invention has advantageously one or more of the following details or characteristics:
The frame (20) is associated to at least one associated element selected among the group consisting of a seat stay (31), a rear chainstay (29) suitable for supporting the rear wheel (22), a fork (27) suitable for supporting the front wheel (21), a front mudguard (30) adapted to cover at least partially the upper part of the front wheel (21), a rear mudguard (3) adapted to cover at least partially the upper part of the rear wheel (22), and a cap (4),
whereby said at least one associated element is an aerodynamic symmetrical profiled element having a plane of symmetry (12) and a curved front end (10) with at least one leading edge, wherein in position of the profiled element with the plane of symmetry (12) located in a vertical plane with the wheeled vehicle rolling on the horizontal rolling plane, said profiled element (3,4,27,29,30,31) has the curved front end (10), a rear end (11), and on either side of said plane of symmetry (12), a curved outer face (13,14), said curved outer faces (13,14) defining in each cross section plane perpendicular to the plane of symmetry (12) and parallel to said horizontal rolling plane (H), a cross-section aerodynamic profile (15),
whereby, at least for a part of the profiled element (3,4), the said cross- section aerodynamic profile (15) has at least 90% of a central part of a sage leaf profile with a ratio [ maximum spacing (E)/maximum cord (C)] comprised between 0.1 and 0.3, advantageously between 0.1 and 0.25, preferably between 0.2 and 0.25, whereby the maximum spacing (E) is measured perpendicular to the plane of symmetry (12), while the maximum cord (C) measured in the plane of symmetry (12);
wherein said sage leaf profile (15) with a ratio [maximum spacing (E)/maximum cord (C)] comprised between 0.1 and 0.3, advantageously between 0.1 and 0.25, preferably between 0.2 and 0.25, comprises two symmetrical curved shapes (13 ,14) with respect to said plane of symmetry (12) of the profiled element, each curved shape (13,14) of said two symmetrical curved shapes (13,14) extending between a first front point (16) and a second rear point (17), said first front point and second rear point (16,17) extending along an axis of symmetry (AX) which extends within the plane of symmetry (12),
wherein each curved shape (13,14) of said two symmetrical curved shapes (13,14) of said sage leaf profile is defined substantially by 5 to 10 successive arcs of circles, (A1 of circle C1, A2 of circle C2, A3 of circle C3, A4 of circle C4, A5 of circle C5), said successive arc of circles being each characterised by a centre of curvature and a radius of curvature, whereby said successive arcs of circles (A1, A2, A3,A4,A5) are interior tangent two by two with increasing radius of curvature (R1,R2,R3,R4,R5) from a minimum radius of curvature (R1) for a curved part in the vicinity of the first front point (16) and a maximum radius of curvature (R5) for a curved part in the vicinity of the second rear point (17), whereby the arc of circle (A1) of the curved part in the vicinity of the first front point (16) is passing through the first front point (16), has its centre of curvature (CC1) located along said axis of symmetry (AX) of the plane of symmetry (12) and has its radius of curvature corresponding to a first radius of curvature (R1) comprised between 0.2 and 0.3 times the maximum spacing (E) of the sage leaf profile,
wherein each curved shape of the said cross-section aerodynamic profile (15) of the profiled element (1,2,3,4) follows substantially at least 95% of a sage leaf profile pattern with two symmetrical curved patterns, each symmetrical curved pattern of said two symmetrical curved patterns being defined by five successive arcs of circles, which are:
   a first arc of circle (A1) with a first radius of curvature (R1);
   a second arc of circle (A2) with a second radius of curvature (R2) comprised between 1.8 and 2.2 times the first radius of curvature (R1);
   a third arc of circle (A3) with a third radius of curvature (R3) comprised between 8.5 and 10.5 times the first radius of curvature (R1);
   a fourth arc of circle (A4) with a fourth radius of curvature (R4) comprised between 25 and 30 times the first radius of curvature (R1); and
   a fifth arc of circle (A5) with a fifth radius of curvature (R5) comprised between 50 and 70 times the first radius of curvature (R1). And/or
at least an element selected from the group consisting of said at least one frame part and said at least one associated element is such that, for each symmetrical curved pattern of the sage leaf profile pattern defined by the five successive arcs of circles, the circles defining the said 5 arcs of circles are inner tangent circles two by two, the first circle (C1) defining the first arc of a circle (A1) being inner tangent to the second circle (C2) at a first point of tangency, the second circle (C2) defining the second arc of a circle (A2) being interior tangent to the third circle (C3) at a second point of tangency, the third circle (C3) defining the third arc of a circle (A3) being interior tangent to the fourth circle (C4) at a third point of tangency, and the fourth circle (C4) defining the fourth arc of a circle (A4) being interior tangent to the fifth circle (C5) defining the fifth arc of a circle (A5) at a fourth point of tangency, said first point of tangency, said second point of tangency, said third point of tangency and said fourth point of tangency defining a series of distinct points of tangency (T1,T2,T3,T4). And/or
at least an element selected from the group consisting of at least one frame part and at least one associated element is such that the sage leaf profile has a ratio [maximum spacing (E)/maximum cord (C)] comprised between 0.1 and 0.25, while each curved shape (13,14) of said two symmetrical curved shapes (13,14) of said sage leaf profile is defined substantially by a number of successive arcs of circles selected from the group consisting of 5, 6 and 7. And/or
at least for a part of the profiled element (1,2,23,25), the said cross-section aerodynamic profile (15) has at least 95% of the central part of the sage leaf profile, said sage leaf profile having a ratio [maximum spacing (E)/maximum cord (C)] comprised between 0.2 and 0.25. And/or
the aerodynamic symmetrical profiled element (1,2,23,25) is at least partially hollow. And/or
with respect to the plane of symmetry (12) of the profiled element (1,2,23,25) located in a vertical plane for the wheeled vehicle (V) resting on the horizontal rolling plane (H), the profiled element (1,2,23,25) has at least:
   a first portion of the profiled element extending between, on the one hand, a lower cross-section plane (P1) of the profiled element, said lower cross-section plane (P1) being parallel to the horizontal rolling plane (H), and, on the other hand, a first intermediate cross-section plane (P2) of the profiled element parallel to the lower cross-section plane (P1), and
   a second portion of the profiled element extending between, on the one hand, a second intermediate cross-section plane parallel to the lower cross- section plane (P1), said second intermediate cross-section plane being selected from the group consisting of the first intermediate cross-section plane (P2) and a different intermediate cross-section plane different from the first intermediate cross-section plane (P2), and, on the other hand, an upper cross-section plane (P3) of the profiled element (3) parallel to the lower cross-section plane (P1),
wherein the first intermediate plane (P2) extends between the lower cross-section plane (P1) and the upper cross-section plane (P3), while the second intermediate cross-section plane is a cross-section plane selected from the group consisting of the first intermediate cross-section plane (P2) and a cross-section plane extending between the first intermediate cross-section plane (P2) and the upper cross-section plane (P3);
wherein said first portion of the profiled element (1,2,23,25) has, for each cross-section plane parallel to the lower cross-section plane (P1) between the lower cross-section plane (P1) and the first intermediate cross-section plane (P2), a first cross-section aerodynamic profile following substantially at least 95% of a first substantially constant sage leaf profile pattern defined by a cord (C) measured in the vertical plane of symmetry (12) and a maximum spacing (E) measured perpendicular to the vertical plane of symmetry (12), such that the ratio [said maximum spacing (E)/said maximum cord (C)] of said first substantially constant sage leaf profile pattern is comprised between 0.1 and 0.3, advantageously between 0.1 and 0.25, preferably between 0.2 and 0.25,
in which the second portion of the profiled element has, for each cross-section plane parallel to the lower cross-section plane (P1) and extending between the second intermediate cross-section plane and the upper cross-section plane (P3), a variable cross-section aerodynamic profile following substantially at least 95% of a variable sage leaf profile pattern that varies continuously between
   a maximum sage leaf profile pattern defined by a maximum cord (C) measured in the vertical plane of symmetry (12) and a maximum spacing (E) measured perpendicular to the plane of symmetry (12), and
   a minimum sage leaf profile pattern defined by a minimum cord (C′) measured in the vertical plane of symmetry (12) less than the maximum cord (C) and a minimum spacing (E′) less than the maximum spacing (E),
      whereby each variable sage leaf profile pattern has a ratio [ spacing (E,E′) measured perpendicular to the plane of symmetry/cord (C,C′) measured in the plane of symmetry (12)] comprised between 0.1 and 0.3, advantageously between 0.1 and 0.25, preferably between 0.2 and 0.25. And/or
the first substantially constant sage leaf profile pattern and the variable sage leaf profile pattern have a ratio [spacing measured perpendicular to the plane of symmetry/cord measured in the plane of symmetry] comprised between 0.1 and 0.25. And/or
the first substantially constant sage leaf profile pattern and the variable sage leaf profile pattern have a ratio [spacing measured perpendicular to the plane of symmetry/cord measured in the plane of symmetry] comprised between 0.2 and 0.25. And/or
a combination of two or more than two of said details.

Another subject of the invention is a wheeled vehicle, such as advantageously a bicycle, comprising a frame according to the invention and/or associated with a profiled element according to the invention, for example in the form of a cover or partial cover.

According to a particular embodiment of the wheeled vehicle or bicycle according to the invention, for which when it is in an upright position with the wheels resting on a horizontal plane (H), the symmetrical aerodynamic profiled element (3) of at least one element chosen from among the saddle profile (23), the steering profile (25), the diagonal profile (1), the optional substantially horizontal profile (2), the optional front mudguard (30), the optional rear mudguard (3) and the optional cap (4), optionally in combination with one another, has at least one portion with, in horizontal cross section, a sage leaf cross section as defined for the profile according to the invention as above.

Yet another object of the invention is the use of a wheeled vehicle suitable for moving on land at a speed of less than 100 km/h in a horizontal plane, said vehicle comprising at least one profiled element according to the invention, in particular at least one frame according to the invention, for generating at least one motor force of between 2N and 10N in the travel direction of the vehicle by the effect of winds on said at least one profiled element for at least winds of speed between 10 km/h and 80 km/h with an angle of attack or incidence angle at least comprised between 10° and 170° with respect to the travel direction of the vehicle.

In particular, the use according to the invention is a use for generating at least one motor force of between 2N and 10N in the travel direction of the vehicle by the effect of winds on said at least one profiled element for at least wind speeds between 10 km/h and 80 km/h with an angle of incidence at least within the range of 10° to 170° with respect to the travel direction of the vehicle.

Advantageously, the generated driving force generates a driving power which is the product of said driving force by the forward speed of the cyclist.

The invention therefore makes it possible to use the wind to generate a driving force for the vehicle, whether the wind comes from the front, orthogonal to the displacement, or by rear wind relative to the vehicle's forward speed, for winds with a speed of, for example, 10 to 60 km/h. This makes it possible to reduce the effort required by a cyclist and/or by the assistance motor of the bicycle by approximately 10 to 40%, thus allowing to the cyclist a less fatigue and to the battery a longer duration of action. Thus, if the power of a cyclist moving at around 30 km/h with a headwind or front wind of 20 to 50 km/h with an angle of incidence of 15 to 45° with respect to the travel direction is about 200W with a traditional bicycle, the power required for the same cyclist using a bicycle with a frame according to the invention is reduced by 10 to 35%.

A vehicle of the invention is thus a wheeled vehicle (V) adapted to move at least on a surface defining a horizontal rolling plane at a speed of less than 100 km/h, said wheeled vehicle comprising a frame supporting at least one front wheel (21) and one rear wheel (22), said frame (20) comprising at least one frame part selected from the group consisting of
(a) a saddle profile (23) with a lower end (23A) and an upper end (23B) adapted to support a saddle post (24),
(b) a steering profile (25) adapted to receive a steering stem (26) associated at least with a fork (27) for at least one front wheel (21), and with a handlebar (28), and
(c) a diagonal profile (1) connecting the lower end (23A) of the saddle profile (23) to the steering profile (25),
(d) a substantially horizontal profile (2) connecting the upper end (23B) of the saddle profile (23) to said steering profile (25), and
(e) an integrated frame part integrating at least partly at least two elements selected form the group consisting of the saddle profile (23), the steering profile (25), the diagonal profile (1) and the substantially horizontal profile (2);
in which said at least one frame part is an aerodynamic symmetrical profiled element having a plane of symmetry (12) and a curved front end (10) with at least one leading edge, wherein in position of the profiled element with the plane of symmetry (12) located in a vertical plane with the wheeled vehicle rolling on the horizontal rolling plane, said profiled element (1,2,23,25) has the curved front end (10), a rear end (11), and on either side of said plane of symmetry (12), a curved outer face (13,14), said curved outer faces (13,14) defining in each cross section plane perpendicular to the plane of symmetry (12) and parallel to said horizontal rolling plane (H), a cross-section aerodynamic profile (15),
whereby at least for a part of the profiled element (1,2,23,25), the said cross-section aerodynamic profile (15) has at least 90% of a central part of a sage leaf profile with a ratio [maximum spacing (E)/maximum cord (C)] comprised between 0.1 and 0.3, advantageously between 0.1 and 0.25, preferably between 0.2 and 0.25, whereby the maximum spacing (E) is measured perpendicular to the plane of symmetry (12), while the maximum cord (C) measured in the plane of symmetry (12);
wherein said sage leaf profile (15) with a ratio [maximum spacing (E)/maximum cord (C)] comprised between 0.1 and 0.3, advantageously between 0.1 and 0.25, preferably between 0.2 and 0.25, comprises two symmetrical curved shapes (13,14) with respect to said plane of symmetry (12) of the profiled element, each curved shape (13,14) of said two symmetrical curved shapes (13,14) extending between a first front point (16) and a second rear point (17), said first front point and second rear point (16,17) extending along an axis of symmetry (AX) which extends within the plane of symmetry (12),
wherein each curved shape (13,14) of said two symmetrical curved shapes (13,14) of said sage leaf profile is defined substantially by 5 to 10 successive arcs of circles (A1 of circle C1, A2 of circle C2, A3 of circle C3, A4 of circle C4, A5 of circle C5), said successive arcs of circles being each characterised by a centre of curvature and a radius of curvature, whereby said successive arcs of circles (A1, A2, A3,A4,A5) are interior tangent two by two with increasing radius of curvature (R1,R2,R3,R4,R5) from a minimum radius of curvature (R1) for a curved part in the vicinity of the first front point (16) and a maximum radius of curvature (R5) for a curved part in the vicinity of the second rear point (17), whereby the arc of circle (A1) of the curved part in the vicinity of the first front point (16) is passing through the first front point (16), has its centre of curvature (CC1) located along said axis of symmetry (AX) of the plane of symmetry (12) and has its radius of curvature corresponding to a first radius of curvature (R1) comprised between 0.2 and 0.3 times the maximum spacing (E) of the sage leaf profile,
wherein each curved shape of the said cross-section aerodynamic profile (15) of the profiled element (1,2,23,25) follows substantially at least 95% of a sage leaf profile pattern with two symmetrical curved patterns, each symmetrical curved pattern of said two symmetrical curved patterns being defined by five successive arcs of circles, which are:
   a first arc of circle (A1) with a first radius of curvature (R1);
   a second arc of circle (A2) with a second radius of curvature (R2) comprised between 1.8 and 2.2 times the first radius of curvature (R1);
   a third arc of circle (A3) with a third radius of curvature (R3) comprised between 8.5 and 10.5 times the first radius of curvature (R1);
   a fourth arc of circle (A4) with a fourth radius of curvature (R4) comprised between 25 and 30 times the first radius of curvature (R1); and
   a fifth arc of circle (A5) with a fifth radius of curvature (R5) comprised between 50 and 70 times the first radius of curvature (R1).

According to advantageous embodiments of the wheeled vehicle of the invention, the wheeled vehicle has advantageously one or more of the details or characteristics of the frame of the invention or the profiled element of the invention, as disclosed here above in the present specification. The wheeled vehicle of the invention is advantageously a bicycle, and/or is provided with at least one electrical battery, at least one motor for driving into rotation at least one wheel, and at least electric supply system connecting the at least one battery with the at least one motor.

According to another wheeled vehicle of the invention, the vehicle is a wheeled vehicle (V) adapted to move at least on a surface defining a horizontal rolling plane at a speed of less than 100 km/h, said wheeled vehicle comprising a frame supporting at least one wheel (21), whereby said frame (20) is associated to at least one associated element selected among the group consisting of a seat stay (31), a rear chain stay (29) suitable for supporting a wheel (22), a fork (27) suitable for supporting a wheel (21), a mudguard (3, 30) adapted to cover at least partially an upper part of a wheel (21), and a cap (4),
whereby said at least one associated element is an aerodynamic symmetrical profiled element having a plane of symmetry (12) and a curved front end (10) with at least one leading edge, wherein in position of the profiled element with the plane of symmetry (12) located in a vertical plane with the wheeled vehicle rolling on the horizontal rolling plane, said profiled element (3,4,27,29,30,31) has the curved front end (10), a rear end (11), and on either side of said plane of symmetry (12), a curved outer face (13,14), said curved outer faces (13,14) defining in each cross section plane perpendicular to the plane of symmetry (12) and parallel to said horizontal rolling plane (H), a cross-section aerodynamic profile (15),
whereby at least for a part of the profiled element (3,4,27,29,30,31), the said cross-section aerodynamic profile (15) has at least 90% of a central part of a sage leaf profile with a ratio [ maximum spacing (E)/maximum cord (C)] comprised between 0.1 and 0.3, whereby the maximum spacing (E) is measured perpendicular to the plane of symmetry (12), while the maximum cord (C) measured in the plane of symmetry (12);
wherein said sage leaf profile (15) with a ratio [maximum spacing (E)/maximum cord (C)] comprised between 0.1 and 0.3, comprises two symmetrical curved shapes (13 ,14) with respect to said plane of symmetry (12) of the profiled element, each curved shape (13,14) of said two symmetrical curved shapes (13,14) extending between a first front point (16) and a second rear point (17), said first front point and second rear point (16,17) extending along an axis of symmetry (AX) which extends within the plane of symmetry (12),
wherein each curved shape (13,14) of said two symmetrical curved shapes (13,14) of said sage leaf profile is defined substantially by 5 to 10 successive arcs of circles (A1 of circle C1, A2 of circle C2, A3 of circle C3, A4 of circle C4, A5 of circle C5), said successive arc of circles being each characterised by a centre of curvature and a radius of curvature, whereby said successive arcs of circles (A1, A2, A3,A4,A5) are interior tangent two by two with increasing radius of curvature (R1,R2,R3,R4,R5) from a minimum radius of curvature (R1) for a curved part in the vicinity of the first front point (16) and a maximum radius of curvature (R5) for a curved part in the vicinity of the second rear point (17), whereby the arc of circle (A1) of the curved part in the vicinity of the first front point (16) is passing through the first front point (16), has its centre of curvature (CC1) located along said axis of symmetry (AX) of the plane of symmetry (12) and has its radius of curvature corresponding to a first radius of curvature (R1) comprised between 0.2 and 0.3 times the maximum spacing (E) of the sage leaf profile,
wherein each curved shape of the said cross-section aerodynamic profile (15) of the profiled element (1,2,3,4) follows substantially at least 95% of a sage leaf profile pattern with two symmetrical curved patterns, each symmetrical curved pattern of said two symmetrical curved patterns being defined by five successive arcs of circles, which are:
   a first arc of circle (A1) with a first radius of curvature (R1);
   a second arc of circle (A2) with a second radius of curvature (R2) comprised between 1.8 and 2.2 times the first radius of curvature (R1);
   a third arc of circle (A3) with a third radius of curvature (R3) comprised between 8.5 and 10.5 times the first radius of curvature (R1);
   a fourth arc of circle (A4) with a fourth radius of curvature (R4) comprised between 25 and 30 times the first radius of curvature (R1); and
   a fifth arc of circle (A5) with a fifth radius of curvature (R5) comprised between 50 and 70 times the first radius of curvature (R1).

According to advantageous embodiments of the said another wheeled vehicle of the invention, the wheeled vehicle has advantageously one or more of the details or characteristics of the frame of the invention or the profiled element of the invention, as disclosed here above in the present specification. The wheeled vehicle of the invention is advantageously a bicycle, and/or is provided with at least one electrical battery, at least one motor for driving into rotation at least one wheel, and at least electric supply system connecting the at least one battery with the at least one motor.

The invention further relates to the use of a wheeled vehicle of the invention for displacing persons and/or goods on a surface.

The said use is advantageously:
The use of a wheeled vehicle suitable for moving on earth at a speed of less than 100 km/h in a travel direction on a horizontal plane, while being submitted to at least a wind with a speed between 10 km/h and 80 km/h and with an angle of attack at least comprised between 10° and 170° with respect to the travel direction of the wheeled vehicle,
whereby the wheeled vehicle has at least a frame supporting at least one front wheel (21) and one rear wheel (22), which is shaped for generating at least one motor force of between 2N and 10N in the travel direction of the wheeled vehicle by the effect of the wind with the speed between 10 km/h and 80 km/h and with the angle of attack at least comprised between 10° and 170° with respect to the travel direction of the wheeled vehicle,
whereby said frame (20) comprises at least one frame part selected from the group consisting of:
   (a) a saddle profile (23) with a lower end (23A) and an upper end (23B) adapted to support a saddle post (24),
   (b) a steering profile (25) adapted to receive a steering stem (26) associated at least with a fork (27) for at least one front wheel (21), and with a handlebar (28), and
   (c) a diagonal profile (1) connecting the lower end (23A) of the saddle profile (23) to the steering profile (25),
   (d) a substantially horizontal profile (2) connecting the upper end (23B) of the saddle profile (23) to said steering profile (25), and
   (e) an integrated frame part integrating at least partly at least two elements selected form the group consisting of the saddle profile (23), the steering profile (25), the diagonal profile (1) and the substantially horizontal profile (2);
in which said at least one frame part is an aerodynamic symmetrical profiled element having a plane of symmetry (12) and a curved front end (10) with at least one leading edge, wherein in position of the profiled element with the plane of symmetry (12) located in a vertical plane with the wheeled vehicle rolling on the horizontal rolling plane, said profiled element (1,2,23,25) has the curved front end (10), a rear end (11), and on either side of said plane of symmetry (12), a curved outer face (13,14), said curved outer faces (13,14) defining in each cross section plane perpendicular to the plane of symmetry (12) and parallel to said horizontal rolling plane (H), a cross-section aerodynamic profile (15),
whereby at least for a part of the profiled element (1,2,23,25), the said cross-section aerodynamic profile (15) has at least 90% of a central part of a sage leaf profile with a ratio [maximum spacing (E)/maximum cord (C)] comprised between 0.1 and 0.3, advantageously between 0.1 and 0.25, preferably between 0.2 and 0.25, whereby the maximum spacing (E) is measured perpendicular to the plane of symmetry (12), while the maximum cord (C) measured in the plane of symmetry (12);
wherein said sage leaf profile (15) with a ratio [maximum spacing (E)/maximum cord (C)] comprised between 0.1 and 0.3, advantageously between 0.1 and 0.25, preferably between 0.2 and 0.25, comprises two symmetrical curved shapes (13 ,14) with respect to said plane of symmetry (12) of the profiled element, each curved shape (13,14) of said two symmetrical curved shapes (13,14) extending between a first front point (16) and a second rear point (17), said first front point and second rear point (16,17) extending along an axis of symmetry (AX) which extends within the plane of symmetry (12),
wherein each curved shape (13,14) of said two symmetrical curved shapes (13,14) of said sage leaf profile is defined substantially by 5 to 10 successive arcs of circles (A1 of circle C1, A2 of circle C2, A3 of circle C3, A4 of circle C4, A5 of circle C5), said successive arc of circles being each characterised by a centre of curvature and a radius of curvature, whereby said successive arcs of circles (A1, A2, A3,A4,A5) are interior tangent two by two with increasing radius of curvature (R1,R2,R3,R4,R5) from a minimum radius of curvature (R1) for a curved part in the vicinity of the first front point (16) and a maximum radius of curvature (R5) for a curved part in the vicinity of the second rear point (17), whereby the arc of circle (A1) of the curved part in the vicinity of the first front point (16) is passing through the first front point (16), has its centre of curvature (CC1) located along said axis of symmetry (AX) of the plane of symmetry (12) and has its radius of curvature corresponding to a first radius of curvature (R1) comprised between 0.2 and 0.3 times the maximum spacing (E) of the sage leaf profile,
wherein each curved shape of the said cross-section aerodynamic profile (15) of the profiled element (1,2,23,25) follows substantially at least 95% of a sage leaf profile pattern with two symmetrical curved patterns, each symmetrical curved pattern of said two symmetrical curved patterns being defined by five successive arcs of circles, which are:
   a first arc of circle (A1) with a first radius of curvature (R1);
   a second arc of circle (A2) with a second radius of curvature (R2) comprised between 1.8 and 2.2 times the first radius of curvature (R1);
   a third arc of circle (A3) with a third radius of curvature (R3) comprised between 8.5 and 10.5 times the first radius of curvature (R1);
   a fourth arc of circle (A4) with a fourth radius of curvature (R4) comprised between 25 and 30 times the first radius of curvature (R1); and
   a fifth arc of circle (A5) with a fifth radius of curvature (R5) comprised between 50 and 70 times the first radius of curvature (R1). Most preferably, the wheeled vehicle is a bicycle, for example a bicycle provided with an electric moving assistance (one or more batteries and motors). Or
The use of a wheeled vehicle suitable for moving on earth at a speed of less than 100 km/h in a travel direction on a horizontal plane, while being submitted to at least a wind with a speed between 10 km/h and 80 km/h and with an angle of attack at least comprised between 10° and 170° with respect to the travel direction of the wheeled vehicle,
whereby the wheeled vehicle has at least a frame supporting at least one front wheel (21) and one rear wheel (22), whereby said frame is associated to at least one associated element selected among the group consisting of a seat stay (31), a rear chainstay (29) suitable for supporting the rear wheel (22), a fork (27) suitable for supporting the front wheel (21), a front mudguard (30) adapted to cover at least partially the upper part of the front wheel (21), a rear mudguard (3) adapted to cover at least partially the upper part of the rear wheel (22), and a cap (4),
whereby the said at least one associated element is shaped for generating at least one motor force of between 2N and 10N in the travel direction of the wheeled vehicle by the effect of the wind with the speed between 10 km/h and 80 km/h and with the angle of attack at least comprised between 10° and 170° with respect to the travel direction of the wheeled vehicle,
whereby said at least one associated element is an aerodynamic symmetrical profiled element having a plane of symmetry (12) and a curved front end (10) with at least one leading edge, wherein in position of the profiled element with the plane of symmetry (12) located in a vertical plane with the wheeled vehicle rolling on the horizontal rolling plane, said profiled element (3,4,27,29,30,31) has the curved front end (10), a rear end (11), and on either side of said plane of symmetry (12), a curved outer face (13,14), said curved outer faces (13,14) defining in each cross section plane perpendicular to the plane of symmetry (12) and parallel to said horizontal rolling plane (H), a cross-section aerodynamic profile (15),
whereby at least for a part of the profiled element (3,4,27,29,30,31), the said cross-section aerodynamic profile (15) has at least 90% of a central part of a sage leaf profile with a ratio [ maximum spacing (E)/maximum cord (C)] comprised between 0.1 and 0.3, advantageously between 0.1 and 0.25, preferably between 0.2 and 0.25, whereby the maximum spacing (E) is measured perpendicular to the plane of symmetry (12), while the maximum cord (C) measured in the plane of symmetry (12);
wherein said sage leaf profile (15) with a ratio [maximum spacing (E)/maximum cord (C)] comprised between 0.1 and 0.3, advantageously between 0.1 and 0.25, preferably between 0.2 and 0.25, comprises two symmetrical curved shapes (13 ,14) with respect to said plane of symmetry (12) of the profiled element, each curved shape (13,14) of said two symmetrical curved shapes (13,14) extending between a first front point (16) and a second rear point (17), said first front point and second rear point (16,17) extending along an axis of symmetry (AX) which extends within the plane of symmetry (12),
wherein each curved shape (13,14) of said two symmetrical curved shapes (13,14) of said sage leaf profile is defined substantially by 5 to 10 successive arcs of circles (A1 of circle C1, A2 of circle C2, A3 of circle C3, A4 of circle C4, A5 of circle C5), said successive arcs of circles being each characterised by a centre of curvature and a radius of curvature, whereby said successive arcs of circles (A1, A2, A3,A4,A5) are interior tangent two by two with increasing radius of curvature (R1,R2,R3,R4,R5) from a minimum radius of curvature (R1) for a curved part in the vicinity of the first front point (16) and a maximum radius of curvature (R5) for a curved part in the vicinity of the second rear point (17), whereby the arc of circle (A1) of the curved part in the vicinity of the first front point (16) is passing through the first front point (16), has its centre of curvature (CC1) located along said axis of symmetry (AX) of the plane of symmetry (12) and has its radius of curvature corresponding to a first radius of curvature (R1) comprised between 0.2 and 0.3 times the maximum spacing (E) of the sage leaf profile,
wherein each curved shape of the said cross-section aerodynamic profile (15) of the profiled element (1,2,3,4) follows substantially at least 95% of a sage leaf profile pattern with two symmetrical curved patterns, each symmetrical curved pattern of said two symmetrical curved patterns being defined by five successive arcs of circles, which are:
   a first arc of circle (A1) with a first radius of curvature (R1);
   a second arc of circle (A2) with a second radius of curvature (R2) comprised between 1.8 and 2.2 times the first radius of curvature (R1);
   a third arc of circle (A3) with a third radius of curvature (R3) comprised between 8.5 and 10.5 times the first radius of curvature (R1);
   a fourth arc of circle (A4) with a fourth radius of curvature (R4) comprised between 25 and 30 times the first radius of curvature (R1); and
   a fifth arc of circle (A5) with a fifth radius of curvature (R5) comprised between 50 and 70 times the first radius of curvature (R1). Most preferably, the wheeled vehicle is a bicycle, for example a bicycle provided with an electric moving assistance (one or more batteries and motors).

Features and details of the invention will appear from the following description in which reference is made to the accompanying drawings, given as examples only.

### BRIEF DESCRIPTION OF THE DRAWINGS

In these drawings,

FIG. 1 is a side view of a bicycle according to the invention,

FIG. 2 is a sectional view along the line II-II of the diagonal profile of the frame of the bicycle of FIG. 1,

FIG. 3 is a sectional view along the line III-III of the horizontal section of the frame of the bicycle of FIG. 1,

FIGS. 4A, 4B and 4C are sectional views respectively along lines IVA, IVB and IVC of the horizontal profile of the frame of the bicycle of FIG. 1 (see also FIG. 3 for the cutting lines IVA, IVB, IVC),

FIG. 5 is a sectional view along the line V-V of the rear mudguard of the frame of the bicycle of FIG. 1,

FIG. 6 is a sectional view along line VI-VI of the rear mudguard of the frame of the bicycle of FIG. 1,

FIG. 7 is a side view of a bicycle cover or fairing,

FIGS. 8 and 9 are sectional views along lines VIII-VIII and IX-IX of the cover or fairing of FIG. 7,

FIG. 10 is a shape representing the inner tangent circular arcs of one face of a sage leaf profile of the invention,

FIG. 11 is a perspective view of a preferred embodiment of a bicycle of the invention,

FIGS. 12, 13 and 14 are cross-section views of the frame of the bicycle of FIG. 11, along horizontal planes XII-XII, XIII-XIII and XIV-XIV (the wheels being not represented in cross-section),

FIG. 15 is a perspective view of a bicycle similar to the bicycle of FIG. 11,

FIGS. 16, 17 and 18 are cross-section views of the frame of the bicycle of FIG. 15 along the horizontal planes XVI-XVI, XVII-XVII and XVIII-XVIIII (the wheels being not represented in cross-section), and

FIGS. 19 and 20 are perspective views of the frame of the bicycle respectively of FIG. 11 and of FIG. 15, on which the horizontal planes XII-XII, XIII-XIII, XIV-XIV, XVI-XVI, XVII-XVII and XVIII-XVIII are drawn.

### DESCRIPTION OF PREFERRED EMBODIMENTS

In the drawings, reference is made to numerals for designating identical means or means having a same function.

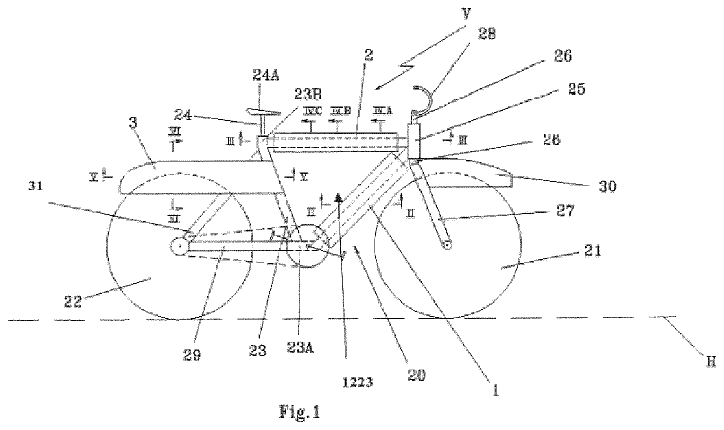

FIG. 1 shows a bicycle (V) with a frame (20) adapted to support at least one front wheel (21) and one rear wheel (22), said frame (20) comprising at least:
(a) a saddle profile (23) with a lower end (23A) and an upper end (23B) adapted to support a saddle post (24) carrying the saddle (24A),
(b) a steering profile (25) adapted to receive a steering stem (26) associated at least with a fork (27) for the front wheel (21), and with a handlebar (28),
(c) a diagonal profile (1) connecting the lower end or portion (23A) of the saddle profile (23) to the steering profile (25), (for this diagonal profile, a tube of a traditional frame is shown in dashed lines.),
(d) a substantially horizontal profile (2) (horizontal when the wheels of the bicycle kept vertical or straight rest on a horizontal plane H) connecting the upper end (23B) of the saddle profile (23) to said steering profile (25), (for this substantially horizontal profile, a tube of a traditional frame has been shown in dashed lines.),
(e) at least a seat stay (31) and a chainstay (29) adapted to support the rear wheel (22),
(f) the fork (27) for the front wheel (21),
(g) a front mudguard (30) adapted to at least partially cover the upper part of the front wheel (21), and
(h) a rear mudguard (3) adapted to at least partially cover the upper part of the rear wheel (22).

The bicycle of FIG. 1 stays in vertical position, with the wheels 21,22 on the horizontal plane H. The bicycle traditionally comprises a drive system, for example with a chain, pedals, toothed wheels, a derailleur unit, and advantageously an electric motor to assist the cyclist in his movement or displacement.

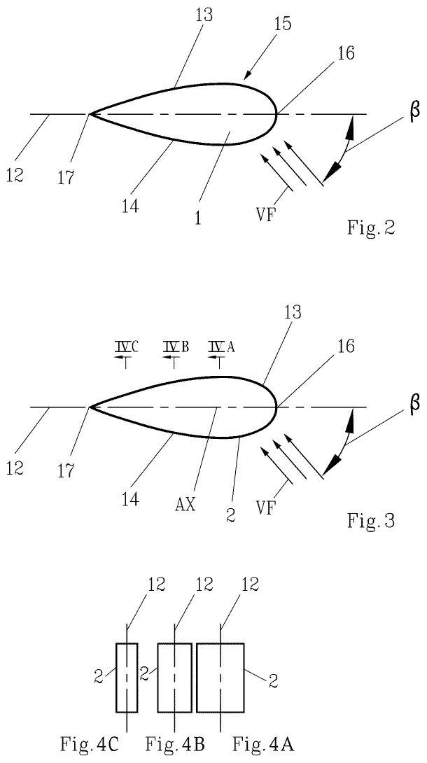

In this bicycle shown by way of example only as a vehicle or wheeled vehicle intended to move in a horizontal plane H at a speed of less than 100 km/h, for example at a maximum speed in the horizontal plane H of 30 to 40 km/h with a headwind (VF in FIG. 2 or FIG. 3) with an angle of incidence (β relative to the plane of symmetry 12) of 5 to 175° (such as, by way of specific examples: 5°,15°, 30°,45°,60°,90°,120°,135°,150°,165° and) 175°)(thus allowing a displacement aid, capable of reducing the muscular power of the cyclist between 5 and 30%), the front mudguard (30), the rear mudguard (3), the substantially horizontal profile (2) and the diagonal profile (1) advantageously has a particular aerodynamic profile with a sage leaf pattern in cross section (along a plane parallel to the horizontal plane when the bicycle is moving on a horizontal plane, while being in vertical position.

The sage leaf profile of these elements has, in cross section perpendicular to the plane of symmetry 12, a ratio [maximum spacing (E) measured perpendicular to the plane of symmetry (12)/maximum cord (C) measured in the plane of symmetry (12)] between 0.1 and 0.3, advantageously between 0.1 and 0.25, preferably between 0.2 and 0.25.

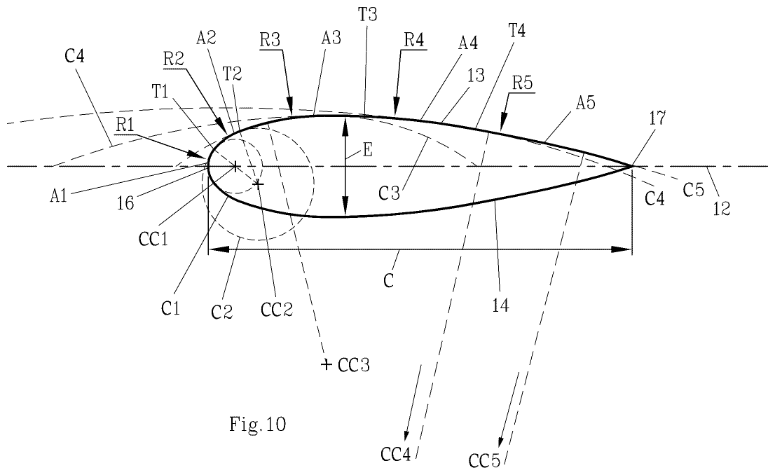

The sage leaf profile (15) of these elements (1,2,3,30) comprises two symmetrical curved shapes (13,14) (forming a hollow space between them) with respect to said substantially vertical plane of symmetry 12, each curved shape (13,14) being formed between a first front point (16) and a second rear point (17) extending in the plane of symmetry (12) and being defined substantially by 5 successive circular arcs (A1, A2, A3, A4, A5) tangent and of increasing radius of curvature (R1, R2, R3, R4, R5) with a minimum radius of curvature for the curved part in the vicinity of the first front point or end (16) and a maximum radius of curvature (R5) for the curved part in the vicinity of the second rear point or end (17), the arc of a circle (A1) of the front end passing through the first front point (16) being defined with a centre of curvature (CC1) located in the plane of symmetry (12) and with a first radius of curvature (R1) comprised between 0.2 and 0.3 times the maximum spacing (E). (see FIG. 10) The centres (CC1, CC2, CC3, CC4, CC5) of the various arcs of curvature or arc of circles (A1, A2, A3, A4, A5) are not aligned along a same line.

With respect to the radius of curvature (R1) of the first arc of circle (A1),
the second circular arc (A2) has a radius of curvature (R2) comprised between 1.8 and 2.2 times the first radius of curvature (R1);
the third arc of a circle (A3) has a radius of curvature (R3) comprised between 8.5 and 10.5 times the first radius of curvature (R1);
the fourth circular arc (A4) has a radius of curvature (R4) comprised between 25 and 30 times the first radius of curvature (R1); and
the fifth circular arc (A5) has a radius of curvature (R5) comprised between 50 and 70 times the first radius of curvature (R1).

The circles (C1, C2, C3, C4, C5) defining the 5 arcs of circles are interior tangent circles two by two, the first circle (C1) defining the first arc of a circle (A1) being interior tangent to the second circle (C2) , the second circle (C2) defining the second arc of a circle (A2) being interior tangent to the third circle (C3), the third circle (C3) defining the third arc of a circle (A3) being interior tangent to the fourth circle (C4) , and the fourth circle (C4) defining the fourth arc of a circle (A4) being interior tangent to the fifth circle (C5) defining the fifth arc of a circle (A5), said interior tangent circles defining a series of distinct points of tangency (T1, T2, T3, T4). Circles C3, C4 and C5 are only partially shown.

Profiles 1 and 2 each have a vertical plane of symmetry (12) for the bicycle (V) in the upright position with the wheels resting on a horizontal plane (H). This vertical plane of symmetry (12) advantageously corresponds to the vertical plane of symmetry of the rear wheel (22) of the bicycle (V). Each horizontal cutting plane (perpendicular to the vertical plane of symmetry (12) with the bicycle V in the upright or straight position, the wheels resting on a horizontal plane (H)) of said profiled elements (1 and 2) defines a cross section having a central axis (AX) horizontal. Over substantially the entire (vertical) height of each of the profiles elements (1 and 2), the cross-section in the horizontal cutting planes remains substantially constant for the bicycle V in the upright position with the wheels resting on a horizontal plane.

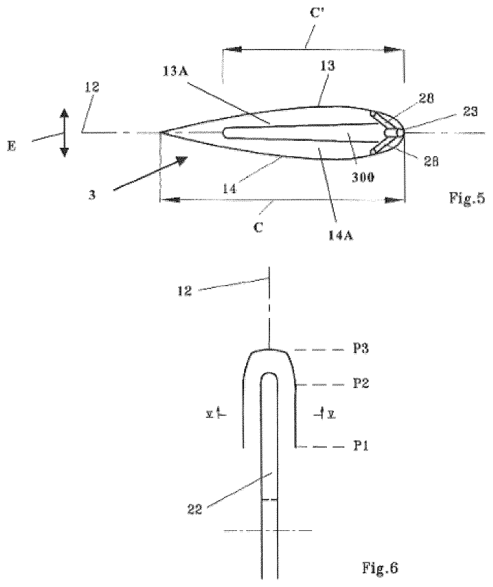

For the profiled element (3) shown in vertical cross section in FIG. 6 (cross section along the line VI-VI in FIG. 1) and in horizontal cross section in FIG. 5 (for the bicycle in an upright position with the wheels resting on a horizontal plane (H)), the profiled element (3) has a vertical plane of symmetry (12). For a first portion of the profiled element (3) extending between a lower plane (P1) and an intermediate plane (P2) (said planes (P1) and (P2) being horizontal and perpendicular to the vertical plane of symmetry (12) for the bike in an upright position with the wheels resting on a horizontal plane (H)), it has faces (13 and 14) symmetrical with respect to the vertical plane (12). For this first portion, it has a sage leaf horizontal cross-section (defined by lines 13 and 14 in FIG. 5) which is constant between the lower plane (P1) and the intermediate plane (P2). This sage leaf horizontal cross section has a cord (C) and a spacing (E)

For a second portion of the profile (3) extending between the intermediate horizontal plane (P2) and an upper horizontal plane (P3) for the bicycle (V) in the standing or upright position with the wheels resting on a horizontal plane, this second portion is defined by the faces (13A) and (14A). Along horizontal cutting planes, the sage leaf cross section of this second portion varies continuously between a maximum sage leaf cross section (corresponding to the cross section in the intermediate plane (P2)) with a maximum cord (C) and a maximum spacing (E), and a minimum sage leaf cross section (corresponding to the sage leaf cross section in the upper plane (P3)) with a cord (C′) less than the maximum cord (C) and a spacing (E′) reduced compared to the maximum spacing (E). For this second portion of the profiled element (3), the cord varies continuously between a maximum cord (E) and a minimum cord (E′)

The profiled element (3) is covered by a cap (300) connecting the faces (13A and 14A) of the second portion, at the level of the upper plane (P3). (see FIGS. 5 and 6)

The profiled elements (1, 2, 3 and 30) can be presented as two independent pieces which can be clipped together. For example, profiled elements (1 and 2) have two parts intended to be clipped to each other while enclosing a tube of a traditional frame of a bike.

The tubes 23, 1 and 2 (parts shown in dashed lines for references 1 and 2 in FIG. 1) can be incorporated into a single aerodynamic profiled element (3) according to the invention. The space 1223 defined between the references 1, 2 and 23 can then be closed by a profiled element according to the invention.

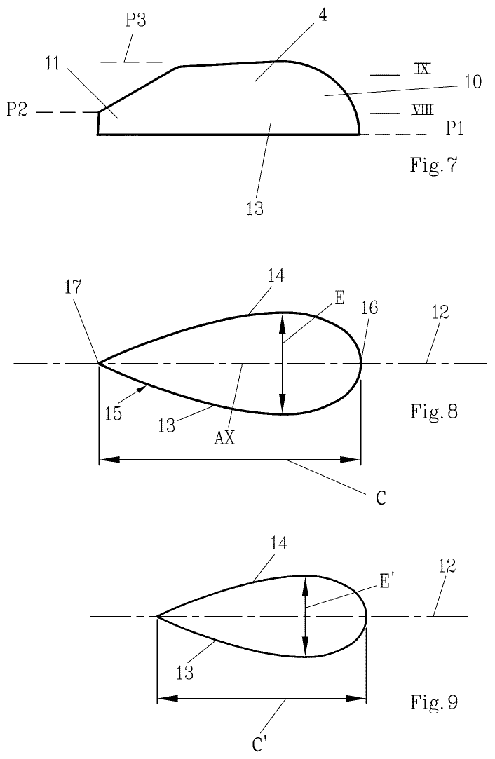

FIG. 7 is a schematic view of a cap or cover (4) which can be mounted on a bicycle by means of fasteners not shown on the frame of the bicycle or on the tray (with or without seat) at the front and/or rear of a cargo bike. This cap (4) forms an interior chamber forming a shelter space for the cyclist and/or forming a housing for the equipment to be transported, for equipment for maintaining the bicycle or for one or more batteries when the bicycle is fitted with electric assistance. This cap (4) has a vertical plane of symmetry (12), a horizontal central axis (AX) for the bicycle (V) in the upright position with the wheels resting in a horizontal plane. In cross-section between the lower and middle horizontal planes (P1 and P2), the horizontal cross-section has a constant sage leaf cross section with an E/C ratio of 0.18 (E being the spacing, while C is the cord), with a cross-sectional profile for each face (13,14) defined by 5 successive circular arcs (arc A1 of circle C1, arc A2 of circle C2, arc A3 of circle C3, arc A4 of circle C4, arc A5 of circle C5) tangent two by two and with a radius of curvature (R1, R2, R3, R4, R5) increasing with a minimum radius of curvature (R1) for the curved part near the front end or leading edge (16) and a maximum radius of curvature (R5) for the curved part in the vicinity of the rear end or tail (17), the arc of circle (A1) of the front end passing through the first front point (16) being defined with a centre of curvature (CC1) situated in the plane of symmetry (12) and with a first radius of curvature (R1) of between 0.2 and 0.3 times the maximum spacing (E). (see FIG. 10) The centres of the different arcs of curvature (CC2 for the arc A2 extending between points T1 and T2, CC3 for the arc A3 extending between points T2 and T3, CC4 for the arc A4 extending between points T3 and T4, CC5 for the arc A5 extending between points T4 and 17) are not aligned along a same line. (see FIG. 10)

Between the intermediate plane (P2) and the upper plane (P3), the profile of the cross section is a sage leaf profile of the type shown in FIG. 10, but whose cord C′ and spacing E′ decrease, closer we are to the upper plane (P3).

The faces (13, 14) of the profiled elements (1, 2, 3, 30) can also be associated with photovoltaic cells to recharge one or more batteries, in particular for a bicycle with electric motor assistance.

FIG. 11 is a perspective view of another preferred embodiment of a bicycle of the invention. Said bicycle is a race bicycle not provided with a front mudguard, nor with a rear mudguard. The chain and the bike pedals have not been represented.

The saddle profile (23) is shaped so as not to follow a constant sage leaf profile. The top portion (23B) of the saddle profile (23) has in cross-section along a horizontal plane XII-XII, a sage leaf pattern (see FIG. 12) similar to the profile pattern of FIG. 10.

In said horizontal cross-section plane XII-XII shown in FIG. 12, the cross-section of the top portion 23B and the cross section of the steering profile 25 with the opening for the steering stem 26 are represented, each having a shape with a sage leaf pattern of the invention, for example as disclosed in FIG. 10.

In the cross section of FIG. 13 still crossing the top portion (23B) (including the saddle post (24)) of the saddle profile (23), the saddle profile (23), two branches of the seat stay (31), the diagonal profile (1) with a hollow (105) for receiving a battery (said hollow 105 can be accessed through a mobile closing plate 104), and the two branches of the fork (27) are represented, each having a shape with a sage leaf pattern of the invention, for example as disclosed in FIG. 10.

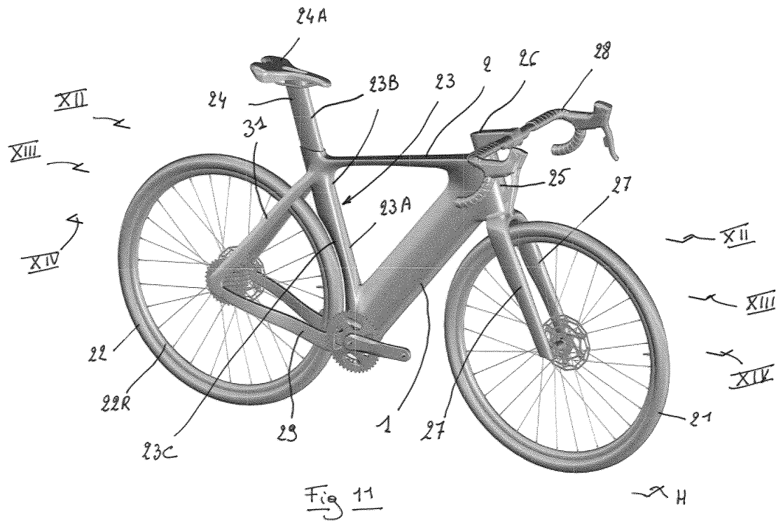

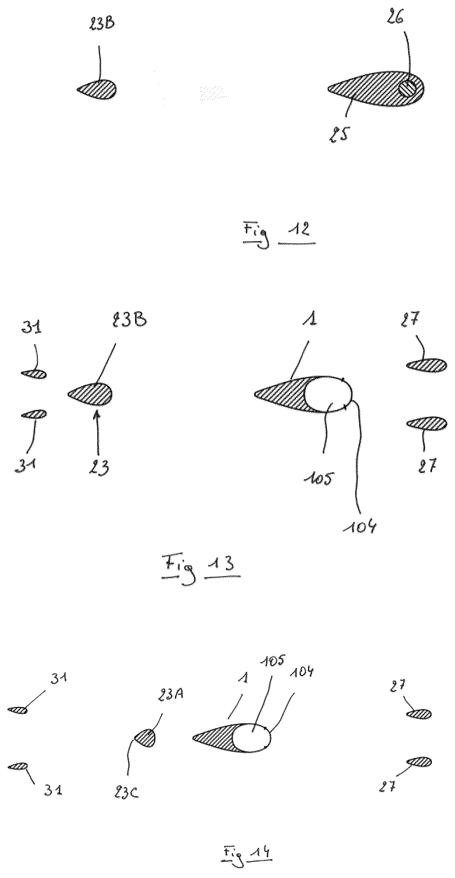

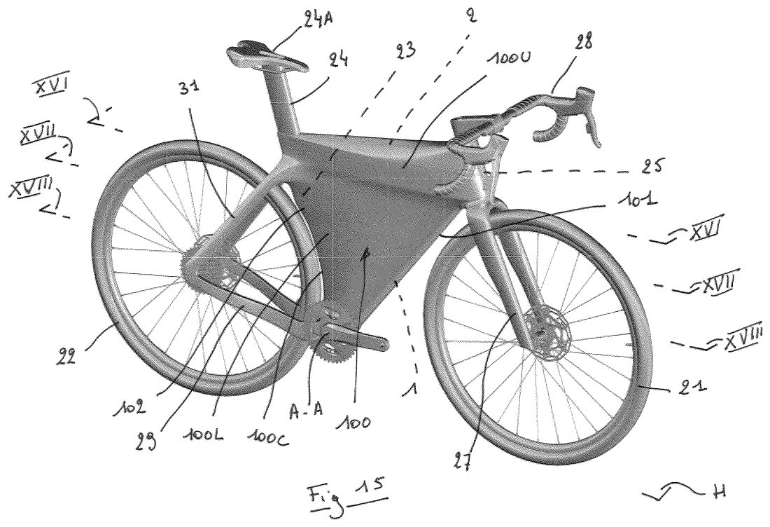

In the cross-section of FIG. 14 crossing the lower portion (23A) of the saddle profile (23), the two branches of the seat profile (31), the diagonal profile (1) and the two branches of the fork (27) are represented, each having a shape with a sage leaf pattern of the invention, for example as disclosed in FIG. 10. The pattern of the cross section of the saddle profile (23) in the plane XIV-XIV follows partly the shape of a sage leaf pattern of the type of FIG. 10. The lower portion (23A) of the saddle profile (23) has a smaller cross-section than the upper or top portion (23B). Said lower portion 23A has a rear curved edge (23C) following the curvature of the rear wheel (22) with the wheel ring support 22A.

The lower portion 23A of the saddle profile 23 has a cross-section for fitting with the shape of the rear wheel (23), whereby the lower portion 23A of the saddle profile 23 integrated with the rear wheel portion adjacent to the saddle profile have each a cross-section shape following a pattern of the type disclosed in FIG. 10.

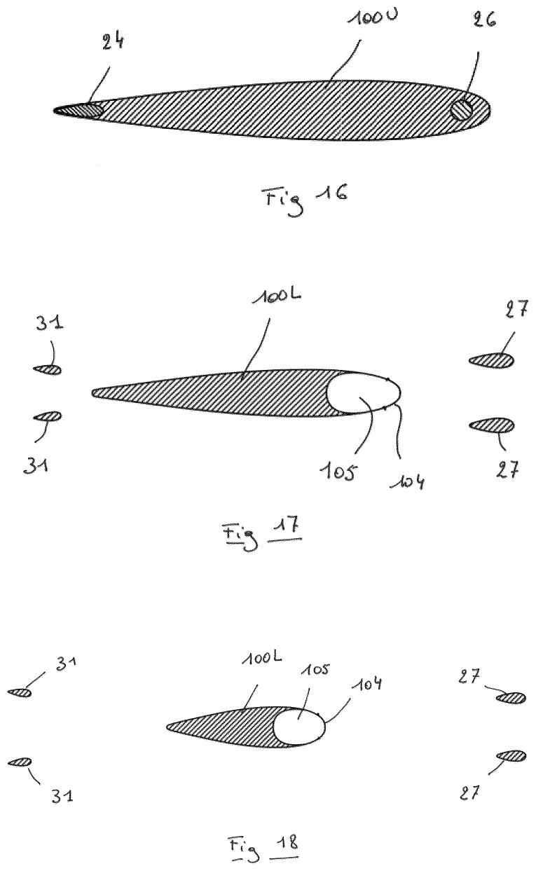

The bicycle of FIG. 15 is similar to the bicycle of FIG. 11, except that the saddle profile 23, the horizontal profile 2, the steering profile 25 and the diagonal profile 1 are integrated to form one single aerodynamic profiled element 100, with horizontal cross-sections in the form of sage leave of the type of FIG. 10.

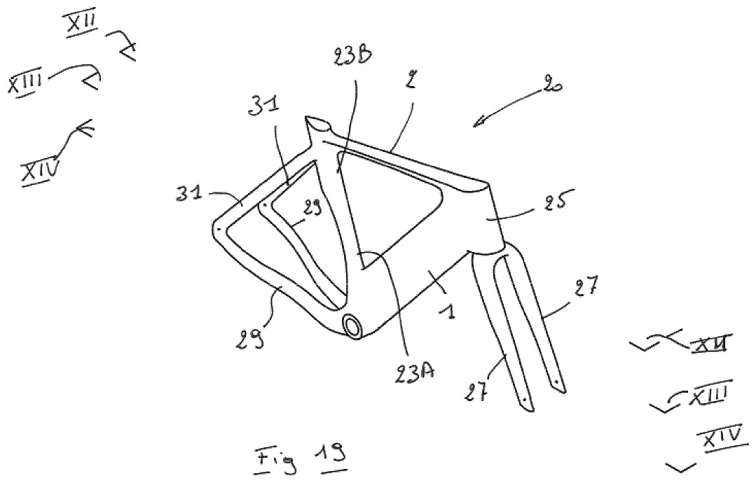

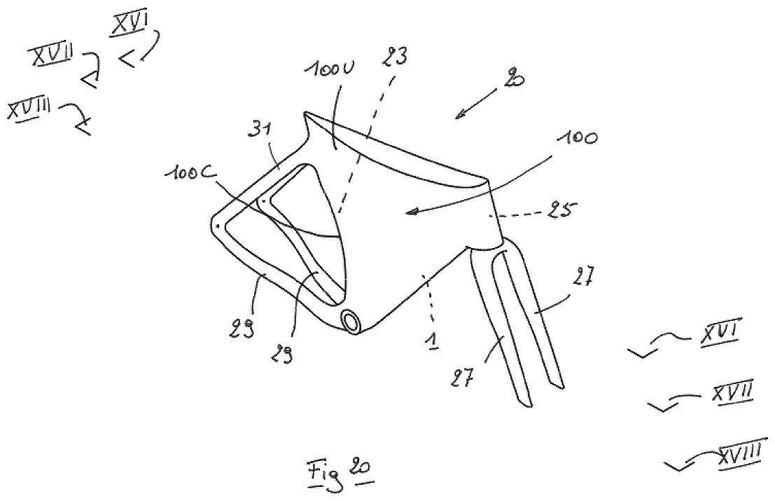

The profiled element 100 have an upper profiled part (100U) with a substantially constant cross-section pattern (see FIG. 16-part extending at the level of steering profile 25 and the top portion 23B of the saddle profile 23) of the type disclosed in FIG. 10, and a lower profiled part (100L) having a cross section varying substantially constantly from a maximum profiled cross-section (see FIG. 17) adjacent to the upper part (100U) to a minimum profiled cross-section (see FIG. 18) adjacent to the rotation axis (A-A) of the pedals.

As shown from FIGS. 16 to 18 which are cross-section views in horizontal planes of the bicycle of FIG. 15, the integrated single profiled element 100 is at least partly hollow, with a front edge part 101 with an opening for the stem 26, and a rear part 102 for bearing the saddle 24A and its post 24. The said cross section profile has a pattern similar to the pattern of FIG. 10. The two branches of the seat stay 31, as well as of the two branches of the fork 27 have also each a cross section profile of the type shown in FIG. 10.

The lower profiled part (100L) has a curved rear end face 100C with a curvature following the curvature of the portion of the rear wheel 22 which is adjacent to said end face 100C.

The aerodynamic integrated profile 100 has in said planes XVI-XVI , XVII-XVII and XVIII-XVIII a pattern corresponding to at least about 95% of the profile of FIG. 10.

At the rear part 102, the end rear face has been shaped so as to fit with a portion of the rear wheel 22 (and its ring support 22R). The wheel part 22 adjacent to the integrated part 100 forms a kind of extension of the cross section pattern of the integrated part 100.

The profile 1 or 100 can be at least partially hollow (hollow 105) and can be provided with an opening associated with a movable closing plate 104. By opening the closing plate 104, a battery can be placed into the hollow 105 of the profile 1 or 100.

In still another possible embodiment, the profiled element can integrate into one single element, the horizontal profile 2, the saddle profile 23, the two branches of the seat stay 31, the steering profile 25, the diagonal profile and the chain stay profile 29, the profiled element having a shape following in cross-section a pattern corresponding to substantially to the profile of FIG. 10.

In the examples of the FIGS. 1, 11 and 15, reference is made to a bicycle. It is obvious that the bicycle is given as a specific example of wheeled vehicle, and that the wheeled vehicle can be provided with three, four, etc different wheels. the vehicle can also be moved at least partly via a system different form a system comprising a chain and pedals. The wheeled vehicle can be provided with a motor and batteries for driving the vehicle.

1. An aerodynamic symmetrical profiled element for a wheeled vehicle (V) adapted to move at least on a surface defining a horizontal rolling plane at a speed of less than 100 km/h, said profiled element (1,2,3,4) having a plane of symmetry (12) and a curved front end (10) with at least one leading edge, wherein in position of the profiled element with the plane of symmetry (12) located in a vertical plane with the wheeled vehicle rolling on the horizontal rolling plane, said profiled element (1,2,3,4) has the curved front end (10), a rear end (11), and on either side of said plane of symmetry (12), a curved outer face (13,14), said curved outer faces (13,14) defining in each cross section plane perpendicular to the plane of symmetry (12) and parallel to said horizontal rolling plane (H), a cross-section aerodynamic profile (15),
whereby at least for a part of the profiled element (1,2,3,4), the said cross- section aerodynamic profile (15) has at least 90% of a central part of a sage leaf profile with a ratio [maximum spacing (E)/maximum cord (C)] comprised between 0.1 and 0.3, whereby the maximum spacing (E) is measured perpendicular to the plane of symmetry (12), while the maximum cord (C) measured in the plane of symmetry (12);
wherein said sage leaf profile (15) with a ratio [maximum spacing (E)/maximum cord (C)] comprised between 0.1 and 0.3, comprises two symmetrical curved shapes (13 ,14) with respect to said plane of symmetry (12) of the profiled element, each curved shape (13,14) of said two symmetrical curved shapes (13,14) extending between a first front point (16) and a second rear point (17), said first front point and second rear point (16,17) extending along an axis of symmetry (AX) which extends within the plane of symmetry (12),
wherein each curved shape (13,14) of said two symmetrical curved shapes (13,14) of said sage leaf profile is defined substantially by 5 to 10 successive arcs of circles (A1 of circle C1, A2 of circle C2, A3 of circle C3, A4 of circle C4, A5 of circle C5), said successive arc of circles being each characterised by a centre of curvature and a radius of curvature, whereby said successive arcs of circles (A1, A2, A3,A4,A5) are interior tangent two by two with increasing radius of curvature (R1,R2,R3,R4,R5) from a minimum radius of curvature (R1) for a curved part in the vicinity of the first front point (16) and a maximum radius of curvature (R5) for a curved part in the vicinity of the second rear point (17), whereby the arc of circle (A1) of the curved part in the vicinity of the first front point (16) is passing through the first front point (16), has its centre of curvature (CC1) located along said axis of symmetry (AX) of the plane of symmetry (12) and has its radius of curvature corresponding to a first radius of curvature (R1) comprised between 0.2 and 0.3 times the maximum spacing (E) of the sage leaf profile,
wherein each curved shape of the said cross-section aerodynamic profile (15) of the profiled element (1,2,3,4) follows substantially at least 95% of a sage leaf profile pattern with two symmetrical curved patterns, each symmetrical curved pattern of said two symmetrical curved patterns being defined by five successive arcs of circles, which are:
a first arc of circle (A1) with a first radius of curvature (R1);
a second arc of circle (A2) with a second radius of curvature (R2) comprised between 1.8 and 2.2 times the first radius of curvature (R1);
a third arc of circle (A3) with a third radius of curvature (R3) comprised between 8.5 and 10.5 times the first radius of curvature (R1);
a fourth arc of circle (A4) with a fourth radius of curvature (R4) comprised between 25 and 30 times the first radius of curvature (R1); and
a fifth arc of circle (A5) with a fifth radius of curvature (R5) comprised between 50 and 70 times the first radius of curvature (R1).

2. The aerodynamic symmetrical profiled element of claim 1, in which for each symmetrical curved pattern of the sage leaf profile pattern defined by the five successive arcs of circles, the circles defining the said 5 arcs of circles are inner tangent circles two by two, the first circle (C1) defining the first arc of a circle (A1) being inner tangent to the second circle (C2) at a first point of tangency, the second circle (C2) defining the second arc of a circle (A2) being interior tangent to the third circle (C3) at a second point of tangency, the third circle (C3) defining the third arc of a circle (A3) being interior tangent to the fourth circle (C4) at a third point of tangency, and the fourth circle (C4) defining the fourth arc of a circle (A4) being interior tangent to the fifth circle (C5) defining the fifth arc of a circle (A5) at a fourth point of tangency, said first point of tangency, said second point of tangency, said third point of tangency and said fourth point of tangency defining a series of distinct points of tangency (T1,T2,T3,T4).

3. The aerodynamic symmetrical profiled element of claim 1, in which the sage leaf profile has a ratio [maximum spacing (E)/maximum cord (C)] comprised between 0.1 and 0.25.

4. The aerodynamic symmetrical profile element of claim 1, in which each curved shape (13,14) of said two symmetrical curved shapes (13,14) of said sage leaf profile is defined substantially by a number of successive arcs of circles selected from the group consisting of 5, 6 and 7.

5. The aerodynamic symmetrical profile element of claim 1, in which each curved shape of said two symmetrical curved shapes (13,14) of said sage leaf profile is defined substantially by 5 successive arcs of circles.

6. The aerodynamic symmetrical profiled element of claim 1, in which at least for a part of the profiled element (1,2,3,4), the said cross-section aerodynamic profile (15) has at least 95% of said central part of said sage leaf profile, the ratio [maximum spacing (E)/maximum cord (C)] of which being comprised between 0.2 and 0.25.

7. The aerodynamic symmetrical profiled element of claim 1, in which the profiled element (1,2,3,4) is at least partially hollow.

8. The aerodynamic symmetrical profiled element of claim 1, in which, with respect to the plane of symmetry (12) of the profiled element (1,2,3,4) located in a vertical plane for the wheeled vehicle (V) resting on the horizontal rolling plane (H), the profiled element (1,2,3,4) has at least:
a first portion of the profiled element (3) extending between, on the one hand, a lower cross-section plane (P1) of the profiled element (3), said lower cross-section plane (P1) being parallel to the horizontal rolling plane (H), and, on the other hand, a first intermediate cross-section plane (P2) of the profiled element (3) parallel to the lower cross-section plane (P1), and
a second portion of the profiled element (3) extending between, on the one hand, a second intermediate cross-section plane parallel to the lower cross-section plane (P1), said second intermediate cross-section plane being selected from the group consisting of the first intermediate cross- section plane (P2) and a different intermediate cross-section plane different from the first intermediate cross-section plane (P2), and, on the other hand, an upper cross-section plane (P3) of the profiled element (3) parallel to the lower cross-section plane (P1),
wherein the first intermediate plane (P2) extends between the lower cross- section plane (P1) and the upper cross-section plane (P3), while the second intermediate cross-section plane is a cross-section plane selected from the group consisting of the first intermediate cross-section plane (P2) and a cross-section plane extending between the first intermediate cross-section plane (P2) and the upper cross-section plane (P3);
wherein said first portion of the profiled element (3) has, for each cross- section plane parallel to the lower cross-section plane (P1) between the lower cross-section plane (P1) and the first intermediate cross-section plane (P2), a first cross-section aerodynamic profile following substantially at least 95% of a first substantially constant sage leaf profile pattern defined by a cord (C) measured in the vertical plane of symmetry (12) and a maximum spacing (E) measured perpendicular to the vertical plane of symmetry (12), such that the ratio [said maximum spacing (E)/said maximum cord (C)] of said first substantially constant sage leaf profile pattern is comprised between 0.1 and 0.3, in which the second portion of the profiled element (3) has, for each cross-section plane parallel to the lower cross-section plane (P1) and extending between the second intermediate cross-section plane and the upper cross-section plane (P3), a variable cross-section aerodynamic profile following substantially at least 95% of a variable sage leaf profile pattern that varies continuously between
a maximum sage leaf profile pattern defined by a maximum cord (C) measured in the vertical plane of symmetry (12) and a maximum spacing (E) measured perpendicular to the plane of symmetry (12), and
a minimum sage leaf profile pattern defined by a minimum cord (C′) measured in the vertical plane of symmetry (12) less than the maximum cord (C) and a minimum spacing (E′) less than the maximum spacing (E),
whereby each variable sage leaf profile pattern has a ratio [spacing (E,E′) measured perpendicular to the plane of symmetry/cord (C,C′) measured in the plane of symmetry (12)] comprised between 0.1 and 0.3.

9. The aerodynamic symmetrical profiled element of claim 8, in which the first substantially constant sage leaf profile pattern and the variable sage leaf profile pattern have a ratio [spacing measured perpendicular to the plane of symmetry/cord measured in the plane of symmetry] comprised between 0.1 and 0.25.

10. The aerodynamic symmetrical profiled element of claim 9, in which the first substantially constant sage leaf profile pattern and the variable sage leaf profile pattern have a ratio [spacing measured perpendicular to the plane of symmetry/cord measured in the plane of symmetry] comprised between 0.2 and 0.25.

11. The aerodynamic symmetrical profiled element of claim 1, in which, with the wheeled vehicle (V) in an upright position with wheels resting on a horizontal plane (H), the aerodynamic symmetrical profiled element has:
a vertical plane of symmetry (12) and
at least one portion extending between a first horizontal plane perpendicular to said vertical plane of symmetry (12) and a second horizontal plane perpendicular to said vertical plane of symmetry (12), said portion being characterised by a substantially constant horizontal cross-section aerodynamic profile (15) substantially following a constant sage leaf profile pattern defined with a determined length for the cord (C) measured in the vertical plane of symmetry (12) and a determined spacing (E) measured perpendicular to the vertical plane (12).

12. A frame (20) of a wheeled vehicle (V) adapted to move at least on a surface defining a horizontal rolling plane at a speed of less than 100 km/h, whereby said frame is adapted to support at least one front wheel (21) and one rear wheel (22), said frame (20) comprising at least one frame part selected from the group consisting of
(a) a saddle profile (23) with a lower end (23A) and an upper end (23B) adapted to support a saddle post (24),
(b) a steering profile (25) adapted to receive a steering stem (26) associated at least with a fork (27) for at least one front wheel (21), and with a handlebar (28), and
(c) a diagonal profile (1) connecting the lower end (23A) of the saddle profile (23) to the steering profile (25),
(d) a substantially horizontal profile (2) connecting the upper end (23B) of the saddle profile (23) to said steering profile (25), and
(e) an integrated frame part integrating at least partly at least two elements selected form the group consisting of the saddle profile (23), the steering profile (25), the diagonal profile (1) and the substantially horizontal profile (2);
in which said at least one frame part is an aerodynamic symmetrical profiled element (1,2,23,25) having a plane of symmetry (12) and a curved front end (10) with at least one leading edge, wherein in position of the profiled element with the plane of symmetry (12) located in a vertical plane with the wheeled vehicle rolling on the horizontal rolling plane, said profiled element (1,2,23,25) has the curved front end (10), a rear end (11), and on either side of said plane of symmetry (12), a curved outer face (13,14), said curved outer faces (13,14) defining in each cross section plane perpendicular to the plane of symmetry (12) and parallel to said horizontal rolling plane (H), a cross-section aerodynamic profile (15),
whereby at least for a part of the profiled element (1,2,23,25), the said cross-section aerodynamic profile (15) has at least 90% of a central part of a sage leaf profile with a ratio [maximum spacing (E)/maximum cord (C)] comprised between 0.1 and 0.3, whereby the maximum spacing (E) is measured perpendicular to the plane of symmetry (12), while the maximum cord (C) measured in the plane of symmetry (12);
wherein said sage leaf profile (15) with a ratio [maximum spacing (E)/maximum cord (C)] comprised between 0.1 and 0.3, comprises two symmetrical curved shapes (13 ,14) with respect to said plane of symmetry (12) of the profiled element, each curved shape (13,14) of said two symmetrical curved shapes (13,14) extending between a first front point (16) and a second rear point (17), said first front point and second rear point (16,17) extending along an axis of symmetry (AX) which extends within the plane of symmetry (12),
wherein each curved shape (13,14) of said two symmetrical curved shapes (13,14) of said sage leaf profile is defined substantially by 5 to 10 successive arcs of circles (A1 of circle C1, A2 of circle C2, A3 of circle C3, A4 of circle C4, A5 of circle C5), said successive arcs of circles being each characterised by a centre of curvature and a radius of curvature, whereby said successive arcs of circles (A1, A2, A3,A4,A5) are interior tangent two by two with increasing radius of curvature (R1,R2,R3,R4,R5) from a minimum radius of curvature (R1) for a curved part in the vicinity of the first front point (16) and a maximum radius of curvature (R5) for a curved part in the vicinity of the second rear point (17), whereby the arc of circle (A1) of the curved part in the vicinity of the first front point (16) is passing through the first front point (16), has its centre of curvature (CC1) located along said axis of symmetry (AX) of the plane of symmetry (12) and has its radius of curvature corresponding to a first radius of curvature (R1) comprised between 0.2 and 0.3 times the maximum spacing (E) of the sage leaf profile,
wherein each curved shape of the said cross-section aerodynamic profile (15) of the profiled element (1,2,23,25) follows substantially at least 95% of a sage leaf profile pattern with two symmetrical curved patterns, each symmetrical curved pattern of said two symmetrical curved patterns being defined by five successive arcs of circles, which are:
a first arc of circle (A1) with a first radius of curvature (R1);
a second arc of circle (A2) with a second radius of curvature (R2) comprised between 1.8 and 2.2 times the first radius of curvature (R1);
a third arc of circle (A3) with a third radius of curvature (R3) comprised between 8.5 and 10.5 times the first radius of curvature (R1);
a fourth arc of circle (A4) with a fourth radius of curvature (R4) comprised between 25 and 30 times the first radius of curvature (R1); and
a fifth arc of circle (A5) with a fifth radius of curvature (R5) comprised between 50 and 70 times the first radius of curvature (R1).

13. The frame (20) of claim 12, said frame (20) being associated to at least one associated element selected among the group consisting of a seat stay (31), a rear chainstay (29) suitable for supporting the rear wheel (22), a fork (27) suitable for supporting the front wheel (21), a front mudguard (30) adapted to cover at least partially the upper part of the front wheel (21), a rear mudguard (3) adapted to cover at least partially the upper part of the rear wheel (22), and a cap (4),
whereby said at least one associated element is an aerodynamic symmetrical profiled element having a plane of symmetry (12) and a curved front end (10) with at least one leading edge, wherein in position of the profiled element with the plane of symmetry (12) located in a vertical plane with the wheeled vehicle rolling on the horizontal rolling plane, said profiled element (3,4,27,29,30,31) has the curved front end (10), a rear end (11), and on either side of said plane of symmetry (12), a curved outer face (13,14), said curved outer faces (13,14) defining in each cross section plane perpendicular to the plane of symmetry (12) and parallel to said horizontal rolling plane (H), a cross-section aerodynamic profile (15),
whereby, at least for a part of the profiled element (3,4), the said cross- section aerodynamic profile (15) has at least 90% of a central part of a sage leaf profile with a ratio [maximum spacing (E)/maximum cord (C)] comprised between 0.1 and 0.3, whereby the maximum spacing (E) is measured perpendicular to the plane of symmetry (12), while the maximum cord (C) measured in the plane of symmetry (12);
wherein said sage leaf profile (15) with a ratio [maximum spacing (E)/maximum cord (C)] comprised between 0.1 and 0.3, comprises two symmetrical curved shapes (13,14) with respect to said plane of symmetry (12) of the profiled element, each curved shape (13,14) of said two symmetrical curved shapes (13,14) extending between a first front point (16) and a second rear point (17), said first front point and second rear point (16,17) extending along an axis of symmetry (AX) which extends within the plane of symmetry (12),
wherein each curved shape (13,14) of said two symmetrical curved shapes (13,14) of said sage leaf profile is defined substantially by 5 to 10 successive arcs of circles, (A1 of circle C1, A2 of circle C2, A3 of circle C3, A4 of circle C4, A5 of circle C5), said successive arc of circles being each characterised by a centre of curvature and a radius of curvature, whereby said successive arcs of circles (A1, A2, A3,A4,A5) are interior tangent two by two with increasing radius of curvature (R1,R2,R3,R4,R5) from a minimum radius of curvature (R1) for a curved part in the vicinity of the first front point (16) and a maximum radius of curvature (R5) for a curved part in the vicinity of the second rear point (17), whereby the arc of circle (A1) of the curved part in the vicinity of the first front point (16) is passing through the first front point (16), has its centre of curvature (CC1) located along said axis of symmetry (AX) of the plane of symmetry (12) and has its radius of curvature corresponding to a first radius of curvature (R1) comprised between 0.2 and 0.3 times the maximum spacing (E) of the sage leaf profile,
wherein each curved shape of the said cross-section aerodynamic profile (15) of the profiled element (1,2,3,4) follows substantially at least 95% of a sage leaf profile pattern with two symmetrical curved patterns, each symmetrical curved pattern of said two symmetrical curved patterns being defined by five successive arcs of circles, which are:
a first arc of circle (A1) with a first radius of curvature (R1);
a second arc of circle (A2) with a second radius of curvature (R2) comprised between 1.8 and 2.2 times the first radius of curvature (R1);
a third arc of circle (A3) with a third radius of curvature (R3) comprised between 8.5 and 10.5 times the first radius of curvature (R1);
a fourth arc of circle (A4) with a fourth radius of curvature (R4) comprised between 25 and 30 times the first radius of curvature (R1); and
a fifth arc of circle (A5) with a fifth radius of curvature (R5) comprised between 50 and 70 times the first radius of curvature (R1).

14. The frame of claim 13, in which at least an element selected from the group consisting of said at least one frame part and said at least one associated element is such that, for each symmetrical curved pattern of the sage leaf profile pattern defined by the five successive arcs of circles, the circles defining the said 5 arcs of circles are inner tangent circles two by two, the first circle (C1) defining the first arc of a circle (A1) being inner tangent to the second circle (C2) at a first point of tangency, the second circle (C2) defining the second arc of a circle (A2) being interior tangent to the third circle (C3) at a second point of tangency, the third circle (C3) defining the third arc of a circle (A3) being interior tangent to the fourth circle (C4) at a third point of tangency, and the fourth circle (C4) defining the fourth arc of a circle (A4) being interior tangent to the fifth circle (C5) defining the fifth arc of a circle (A5) at a fourth point of tangency, said first point of tangency, said second point of tangency, said third point of tangency and said fourth point of tangency defining a series of distinct points of tangency (T1,T2,T3,T4).

15. The frame of claim 13, in which at least an element selected from the group consisting of at least one frame part and at least one associated element is such that the sage leaf profile has a ratio [maximum spacing (E)/maximum cord (C)] comprised between 0.1 and 0.25, while each curved shape (13,14) of said two symmetrical curved shapes (13,14) of said sage leaf profile is defined substantially by a number of successive arcs of circles selected from the group consisting of 5, 6 and 7.

16. The frame of claim 12, in which at least for a part of the profiled element (1,2,23,25), the said cross-section aerodynamic profile (15) has at least 95% of the central part of the sage leaf profile, said sage leaf profile having a ratio [maximum spacing (E)/maximum cord (C)] comprised between 0.2 and 0.25.

17. The frame of claim 12, in which the aerodynamic symmetrical profiled element (1,2,23,25) is at least partially hollow.

18. The frame of claim 12, in which, with respect to the plane of symmetry (12) of the profiled element (1,2,23,25) located in a vertical plane for the wheeled vehicle (V) resting on the horizontal rolling plane (H), the profiled element (1,2,23,25) has at least:
a first portion of the profiled element extending between, on the one hand, a lower cross-section plane (P1) of the profiled element, said lower cross-section plane (P1) being parallel to the horizontal rolling plane (H), and, on the other hand, a first intermediate cross-section plane (P2) of the profiled element parallel to the lower cross-section plane (P1), and
a second portion of the profiled element extending between, on the one hand, a second intermediate cross-section plane parallel to the lower cross-section plane (P1), said second intermediate cross-section plane being selected from the group consisting of the first intermediate cross-section plane (P2) and a different intermediate cross-section plane different from the first intermediate cross-section plane (P2), and, on the other hand, an upper cross-section plane (P3) of the profiled element (3) parallel to the lower cross-section plane (P1),
wherein the first intermediate plane (P2) extends between the lower cross-section plane (P1) and the upper cross-section plane (P3), while the second intermediate cross-section plane is a cross-section plane selected from the group consisting of the first intermediate cross-section plane (P2) and a cross-section plane extending between the first intermediate cross-section plane (P2) and the upper cross-section plane (P3);
wherein said first portion of the profiled element (1,2,23,25) has, for each cross-section plane parallel to the lower cross-section plane (P1) between the lower cross-section plane (P1) and the first intermediate cross-section plane (P2), a first cross-section aerodynamic profile following substantially at least 95% of a first substantially constant sage leaf profile pattern defined by a cord (C) measured in the vertical plane of symmetry (12) and a maximum spacing (E) measured perpendicular to the vertical plane of symmetry (12), such that the ratio [said maximum spacing (E)/said maximum cord (C)] of said first substantially constant sage leaf profile pattern is comprised between 0.1 and 0.3,
in which the second portion of the profiled element has, for each cross-section plane parallel to the lower cross-section plane (P1) and extending between the second intermediate cross-section plane and the upper cross-section plane (P3), a variable cross-section aerodynamic profile following substantially at least 95% of a variable sage leaf profile pattern that varies continuously between
a maximum sage leaf profile pattern defined by a maximum cord (C) measured in the vertical plane of symmetry (12) and a maximum spacing (E) measured perpendicular to the plane of symmetry (12), and
a minimum sage leaf profile pattern defined by a minimum cord (C′) measured in the vertical plane of symmetry (12) less than the maximum cord (C) and a minimum spacing (E′) less than the maximum spacing (E),
whereby each variable sage leaf profile pattern has a ratio [spacing (E,E′) measured perpendicular to the plane of symmetry/cord (C,C′) measured in the plane of symmetry (12)] comprised between 0.1 and 0.3.

19. The frame of claim 18, in which the first substantially constant sage leaf profile pattern and the variable sage leaf profile pattern have a ratio [spacing measured perpendicular to the plane of symmetry/cord measured in the plane of symmetry] comprised between 0.1 and 0.25.

20. The frame of claim 19, in which the first substantially constant sage leaf profile pattern and the variable sage leaf profile pattern have a ratio [spacing measured perpendicular to the plane of symmetry/cord measured in the plane of symmetry] comprised between 0.2 and 0.25.

21. A wheeled vehicle (V) adapted to move at least on a surface defining a horizontal rolling plane at a speed of less than 100 km/h, said wheeled vehicle comprising a frame supporting at least one front wheel (21) and one rear wheel (22), said frame (20) comprising at least one frame part selected from the group consisting of
(a) a saddle profile (23) with a lower end (23A) and an upper end (23B) adapted to support a saddle post (24),
(b) a steering profile (25) adapted to receive a steering stem (26) associated at least with a fork (27) for at least one front wheel (21), and with a handlebar (28), and
(c) a diagonal profile (1) connecting the lower end (23A) of the saddle profile (23) to the steering profile (25),
(d) a substantially horizontal profile (2) connecting the upper end (23B) of the saddle profile (23) to said steering profile (25), and
(e) an integrated frame part integrating at least partly at least two elements selected form the group consisting of the saddle profile (23), the steering profile (25), the diagonal profile (1) and the substantially horizontal profile (2);
in which said at least one frame part is an aerodynamic symmetrical profiled element having a plane of symmetry (12) and a curved front end (10) with at least one leading edge, wherein in position of the profiled element with the plane of symmetry (12) located in a vertical plane with the wheeled vehicle rolling on the horizontal rolling plane, said profiled element (1,2,23,25) has the curved front end (10), a rear end (11), and on either side of said plane of symmetry (12), a curved outer face (13,14), said curved outer faces (13,14) defining in each cross section plane perpendicular to the plane of symmetry (12) and parallel to said horizontal rolling plane (H), a cross-section aerodynamic profile (15),
whereby at least for a part of the profiled element (1,2,23,25), the said cross-section aerodynamic profile (15) has at least 90% of a central part of a sage leaf profile with a ratio [ maximum spacing (E)/maximum cord (C)] comprised between 0.1 and 0.3, whereby the maximum spacing (E) is measured perpendicular to the plane of symmetry (12), while the maximum cord (C) measured in the plane of symmetry (12);
wherein said sage leaf profile (15) with a ratio [maximum spacing (E)/maximum cord (C)] comprised between 0.1 and 0.3, comprises two symmetrical curved shapes (13 ,14) with respect to said plane of symmetry (12) of the profiled element, each curved shape (13,14) of said two symmetrical curved shapes (13,14) extending between a first front point (16) and a second rear point (17), said first front point and second rear point (16,17) extending along an axis of symmetry (AX) which extends within the plane of symmetry (12),
wherein each curved shape (13,14) of said two symmetrical curved shapes (13,14) of said sage leaf profile is defined substantially by 5 to 10 successive arcs of circles (A1 of circle C1, A2 of circle C2, A3 of circle C3, A4 of circle C4, A5 of circle C5), said successive arcs of circles being each characterised by a centre of curvature and a radius of curvature, whereby said successive arcs of circles (A1, A2, A3,A4,A5) are interior tangent two by two with increasing radius of curvature (R1,R2,R3,R4,R5) from a minimum radius of curvature (R1) for a curved part in the vicinity of the first front point (16) and a maximum radius of curvature (R5) for a curved part in the vicinity of the second rear point (17), whereby the arc of circle (A1) of the curved part in the vicinity of the first front point (16) is passing through the first front point (16), has its centre of curvature (CC1) located along said axis of symmetry (AX) of the plane of symmetry (12) and has its radius of curvature corresponding to a first radius of curvature (R1) comprised between 0.2 and 0.3 times the maximum spacing (E) of the sage leaf profile,
wherein each curved shape of the said cross-section aerodynamic profile (15) of the profiled element (1,2,23,25) follows substantially at least 95% of a sage leaf profile pattern with two symmetrical curved patterns, each symmetrical curved pattern of said two symmetrical curved patterns being defined by five successive arcs of circles, which are:
a first arc of circle (A1) with a first radius of curvature (R1);
a second arc of circle (A2) with a second radius of curvature (R2) comprised between 1.8 and 2.2 times the first radius of curvature (R1);
a third arc of circle (A3) with a third radius of curvature (R3) comprised between 8.5 and 10.5 times the first radius of curvature (R1);
a fourth arc of circle (A4) with a fourth radius of curvature (R4) comprised between 25 and 30 times the first radius of curvature (R1); and
a fifth arc of circle (A5) with a fifth radius of curvature (R5) comprised between 50 and 70 times the first radius of curvature (R1).

22. The wheeled vehicle of claim 21, whereby said frame (20) is associated to at least one associated element selected among the group consisting of a seat stay (31), a rear chainstay (29) suitable for supporting the rear wheel (22), a fork (27) suitable for supporting the front wheel (21), a front mudguard (30) adapted to cover at least partially the upper part of the front wheel (21), a rear mudguard (3) adapted to cover at least partially the upper part of the rear wheel (22), and a cap (4), whereby said at least one associated element is an aerodynamic symmetrical profiled element having a plane of symmetry (12) and a curved front end (10) with at least one leading edge, wherein in position of the profiled element with the plane of symmetry (12) located in a vertical plane with the wheeled vehicle rolling on the horizontal rolling plane, said profiled element (3,4,27,29,30,31) has the curved front end (10), a rear end (11), and on either side of said plane of symmetry (12), a curved outer face (13,14), said curved outer faces (13,14) defining in each cross section plane perpendicular to the plane of symmetry (12) and parallel to said horizontal rolling plane (H), a cross-section aerodynamic profile (15),
whereby at least for a part of the profiled element (3,4,27,29,30,31), the said cross-section aerodynamic profile (15) has at least 90% of a central part of a sage leaf profile with a ratio [ maximum spacing (E)/maximum cord (C)] comprised between 0.1 and 0.3, whereby the maximum spacing (E) is measured perpendicular to the plane of symmetry (12), while the maximum cord (C) measured in the plane of symmetry (12);
wherein said sage leaf profile (15) with a ratio [maximum spacing (E)/maximum cord (C)] comprised between 0.1 and 0.3, comprises two symmetrical curved shapes (13 ,14) with respect to said plane of symmetry (12) of the profiled element, each curved shape (13,14) of said two symmetrical curved shapes (13,14) extending between a first front point (16) and a second rear point (17), said first front point and second rear point (16,17) extending along an axis of symmetry (AX) which extends within the plane of symmetry (12),
wherein each curved shape (13,14) of said two symmetrical curved shapes (13,14) of said sage leaf profile is defined substantially by 5 to 10 successive arcs of circles (A1 of circle C1, A2 of circle C2, A3 of circle C3, A4 of circle C4, A5 of circle C5), said successive arc of circles being each characterised by a centre of curvature and a radius of curvature, whereby said successive arcs of circles (A1, A2, A3,A4,A5) are interior tangent two by two with increasing radius of curvature (R1,R2,R3,R4,R5) from a minimum radius of curvature (R1) for a curved part in the vicinity of the first front point (16) and a maximum radius of curvature (R5) for a curved part in the vicinity of the second rear point (17), whereby the arc of circle (A1) of the curved part in the vicinity of the first front point (16) is passing through the first front point (16), has its centre of curvature (CC1) located along said axis of symmetry (AX) of the plane of symmetry (12) and has its radius of curvature corresponding to a first radius of curvature (R1) comprised between 0.2 and 0.3 times the maximum spacing (E) of the sage leaf profile,
wherein each curved shape of the said cross-section aerodynamic profile (15) of the profiled element (1,2,3,4) follows substantially at least 95% of a sage leaf profile pattern with two symmetrical curved patterns, each symmetrical curved pattern of said two symmetrical curved patterns being defined by five successive arcs of circles, which are:
a first arc of circle (A1) with a first radius of curvature (R1);
a second arc of circle (A2) with a second radius of curvature (R2) comprised between 1.8 and 2.2 times the first radius of curvature (R1);
a third arc of circle (A3) with a third radius of curvature (R3) comprised between 8.5 and 10.5 times the first radius of curvature (R1);
a fourth arc of circle (A4) with a fourth radius of curvature (R4) comprised between 25 and 30 times the first radius of curvature (R1); and
a fifth arc of circle (A5) with a fifth radius of curvature (R5) comprised between 50 and 70 times the first radius of curvature (R1).

23. The wheeled vehicle of claim 22, in which at least an element selected from the group consisting of at least one frame element and at least one associated element is such that for each symmetrical curved pattern of the sage leaf profile pattern defined by the five successive arcs of circles, the circles defining the said 5 arcs of circles are inner tangent circles two by two, the first circle (C1) defining the first arc of a circle (A1) being inner tangent to the second circle (C2) at a first point of tangency, the second circle (C2) defining the second arc of a circle (A2) being interior tangent to the third circle (C3) at a second point of tangency, the third circle (C3) defining the third arc of a circle (A3) being interior tangent to the fourth circle (C4) at a third point of tangency, and the fourth circle (C4) defining the fourth arc of a circle (A4) being interior tangent to the fifth circle (C5) defining the fifth arc of a circle (A5) at a fourth point of tangency, said first point of tangency, said second point of tangency, said third point of tangency and said fourth point of tangency defining a series of distinct points of tangency (T1,T2,T3,T4).

24. The wheeled vehicle of claim 22, in which at least an element selected from the group consisting of at least one frame element and at least one associated element is such that the sage leaf profile has a ratio [maximum spacing (E)/maximum cord (C)] comprised between 0.1 and 0.25, while each curved shape (13,14) of said two symmetrical curved shapes (13,14) of said sage leaf profile is defined substantially by a number of successive arcs of circles selected from the group consisting of 5, 6and 7.

25. The wheeled vehicle of claim 21, in which at least for a part of the profiled element (1,2,23,25), the said cross-section aerodynamic profile (15) has at least 95% of a central part of a sage leaf profile with a ratio [maximum spacing (E)/maximum cord (C)] comprised between 0.2 and 0.25.

26. The wheeled vehicle of claim 21, in which the aerodynamic symmetrical profiled element (1,2,23,25) is at least partially hollow.

27. The wheeled vehicle of claim 21, in which, with respect to the plane of symmetry (12) of the profiled element (1,2,23,25) located in a vertical plane for the wheeled vehicle (V) resting on the horizontal rolling plane (H), the profiled element (1,2,23,25) has at least:
a first portion of the profiled element extending between, on the one hand, a lower cross-section plane (P1) of the profiled element, said lower cross-section plane (P1) being parallel to the horizontal rolling plane (H), and, on the other hand, a first intermediate cross-section plane (P2) of the profiled element parallel to the lower cross-section plane (P1), and
a second portion of the profiled element extending between, on the one hand, a second intermediate cross-section plane parallel to the lower cross-section plane (P1), said second intermediate cross-section plane being selected from the group consisting of the first intermediate cross-section plane (P2) and a different intermediate cross-section plane different from the first intermediate cross-section plane (P2), and, on the other hand, an upper cross-section plane (P3) of the profiled element (3) parallel to the lower cross-section plane (P1),
wherein the first intermediate plane (P2) extends between the lower cross- section plane (P1) and the upper cross-section plane (P3), while the second intermediate cross-section plane is a cross-section plane selected from the group consisting of the first intermediate cross-section plane (P2) and a cross-section plane extending between the first intermediate cross-section plane (P2) and the upper cross-section plane (P3);
wherein said first portion of the profiled element (1,2,23,25) has, for each cross-section plane parallel to the lower cross-section plane (P1) between the lower cross-section plane (P1) and the first intermediate cross-section plane (P2), a first cross-section aerodynamic profile following substantially at least 95% of a first substantially constant sage leaf profile pattern defined by a cord (C) measured in the vertical plane of symmetry (12) and a maximum spacing (E) measured perpendicular to the vertical plane of symmetry (12), such that the ratio [said maximum spacing (E)/said maximum cord (C)] of said first substantially constant sage leaf profile pattern is comprised between 0.1 and 0.3;
in which the second portion of the profiled element has, for each cross- section plane parallel to the lower cross-section plane (P1) and extending between the second intermediate cross-section plane and the upper cross-section plane (P3), a variable cross-section aerodynamic profile following substantially at least 95% of a variable sage leaf profile pattern that varies continuously between
a maximum sage leaf profile pattern defined by a maximum cord (C) measured in the vertical plane of symmetry (12) and a maximum spacing (E) measured perpendicular to the plane of symmetry (12), and
a minimum sage leaf profile pattern defined by a minimum cord (C′) measured in the vertical plane of symmetry (12) less than the maximum cord (C) and a minimum spacing (E′) less than the maximum spacing (E),
whereby each variable sage leaf profile pattern has a ratio [spacing (E,E′) measured perpendicular to the plane of symmetry/cord (C,C′) measured in the plane of symmetry (12)] comprised between 0.1 and 0.3.

28. The wheeled vehicle of claim 27, in which the first substantially constant sage leaf profile pattern and the variable sage leaf profile pattern have a ratio [spacing measured perpendicular to the plane of symmetry/cord measured in the plane of symmetry] comprised between 0.1 and 0.25.

29. The wheeled vehicle of claim 21, which is a bicycle.

30. The wheeled vehicle of claim 21, which is provided with at least one electrical battery, at least one motor for driving into rotation at least one wheel, and at least electric supply system connecting the at least one battery with the at least one motor.

31. A wheeled vehicle (V) adapted to move at least on a surface defining a horizontal rolling plane at a speed of less than 100 km/h, said wheeled vehicle comprising a frame supporting at least one wheel (21), whereby said frame (20) is associated to at least one associated element selected among the group consisting of a seat stay (31), a rear chain stay (29) suitable for supporting a wheel (22), a fork (27) suitable for supporting a wheel (21), a mudguard (3, 30) adapted to cover at least partially an upper part of a wheel (21), and a cap (4),
whereby said at least one associated element is an aerodynamic symmetrical profiled element having a plane of symmetry (12) and a curved front end (10) with at least one leading edge, wherein in position of the profiled element with the plane of symmetry (12) located in a vertical plane with the wheeled vehicle rolling on the horizontal rolling plane, said profiled element (3,4,27,29,30,31) has the curved front end (10), a rear end (11), and on either side of said plane of symmetry (12), a curved outer face (13,14), said curved outer faces (13,14) defining in each cross section plane perpendicular to the plane of symmetry (12) and parallel to said horizontal rolling plane (H), a cross-section aerodynamic profile (15),
whereby at least for a part of the profiled element (3,4,27,29,30,31), the said cross-section aerodynamic profile (15) has at least 90% of a central part of a sage leaf profile with a ratio [maximum spacing (E)/maximum cord (C)] comprised between 0.1 and 0.3, whereby the maximum spacing (E) is measured perpendicular to the plane of symmetry (12), while the maximum cord (C) measured in the plane of symmetry (12);
wherein said sage leaf profile (15) with a ratio [maximum spacing (E)/maximum cord (C)] comprised between 0.1 and 0.3, comprises two symmetrical curved shapes (13 ,14) with respect to said plane of symmetry (12) of the profiled element, each curved shape (13,14) of said two symmetrical curved shapes (13,14) extending between a first front point (16) and a second rear point (17), said first front point and second rear point (16,17) extending along an axis of symmetry (AX) which extends within the plane of symmetry (12),
wherein each curved shape (13,14) of said two symmetrical curved shapes (13,14) of said sage leaf profile is defined substantially by 5 to 10 successive arcs of circles (A1 of circle C1, A2 of circle C2, A3 of circle C3, A4 of circle C4, A5 of circle C5), said successive arc of circles being each characterised by a centre of curvature and a radius of curvature, whereby said successive arcs of circles (A1, A2, A3,A4,A5) are interior tangent two by two with increasing radius of curvature (R1,R2,R3,R4,R5) from a minimum radius of curvature (R1) for a curved part in the vicinity of the first front point (16) and a maximum radius of curvature (R5) for a curved part in the vicinity of the second rear point (17), whereby the arc of circle (A1) of the curved part in the vicinity of the first front point (16) is passing through the first front point (16), has its centre of curvature (CC1) located along said axis of symmetry (AX) of the plane of symmetry (12) and has its radius of curvature corresponding to a first radius of curvature (R1) comprised between 0.2 and 0.3 times the maximum spacing (E) of the sage leaf profile,
wherein each curved shape of the said cross-section aerodynamic profile (15) of the profiled element (1,2,3,4) follows substantially at least 95% of a sage leaf profile pattern with two symmetrical curved patterns, each symmetrical curved pattern of said two symmetrical curved patterns being defined by five successive arcs of circles, which are:
a first arc of circle (A1) with a first radius of curvature (R1);
a second arc of circle (A2) with a second radius of curvature (R2) comprised between 1.8 and 2.2 times the first radius of curvature (R1);
a third arc of circle (A3) with a third radius of curvature (R3) comprised between 8.5 and 10.5 times the first radius of curvature (R1);
a fourth arc of circle (A4) with a fourth radius of curvature (R4) comprised between 25 and 30 times the first radius of curvature (R1); and
a fifth arc of circle (A5) with a fifth radius of curvature (R5) comprised between 50 and 70 times the first radius of curvature (R1).

32. The use of a wheeled vehicle suitable for moving on earth at a speed of less than 100 km/h in a travel direction on a horizontal plane, while being submitted to at least a wind with a speed between 10 km/h and 80 km/h and with an angle of attack at least comprised between 10° and 170° with respect to the travel direction of the wheeled vehicle,
whereby the wheeled vehicle has at least a frame supporting at least one front wheel (21) and one rear wheel (22), which is shaped for generating at least one motor force of between 2N and 10N in the travel direction of the wheeled vehicle by the effect of the wind with the speed between 10 km/h and 80 km/h and with the angle of attack at least comprised between 10° and 170° with respect to the travel direction of the wheeled vehicle,
whereby said frame (20) comprises at least one frame part selected from the group consisting of:
(a) a saddle profile (23) with a lower end (23A) and an upper end (23B) adapted to support a saddle post (24),
(b) a steering profile (25) adapted to receive a steering stem (26) associated at least with a fork (27) for at least one front wheel (21), and with a handlebar (28), and
(c) a diagonal profile (1) connecting the lower end (23A) of the saddle profile (23) to the steering profile (25),
(d) a substantially horizontal profile (2) connecting the upper end (23B) of the saddle profile (23) to said steering profile (25), and
(e) an integrated frame part integrating at least partly at least two elements selected form the group consisting of the saddle profile (23), the steering profile (25), the diagonal profile (1) and the substantially horizontal profile (2);
in which said at least one frame part is an aerodynamic symmetrical profiled element having a plane of symmetry (12) and a curved front end (10) with at least one leading edge, wherein in position of the profiled element with the plane of symmetry (12) located in a vertical plane with the wheeled vehicle rolling on the horizontal rolling plane, said profiled element (1,2,23,25) has the curved front end (10), a rear end (11), and on either side of said plane of symmetry (12), a curved outer face (13,14), said curved outer faces (13,14) defining in each cross section plane perpendicular to the plane of symmetry (12) and parallel to said horizontal rolling plane (H), a cross-section aerodynamic profile (15),
whereby at least for a part of the profiled element (1,2,23,25), the said cross-section aerodynamic profile (15) has at least 90% of a central part of a sage leaf profile with a ratio [maximum spacing (E)/maximum cord (C)] comprised between 0.1 and 0.3, whereby the maximum spacing (E) is measured perpendicular to the plane of symmetry (12), while the maximum cord (C) measured in the plane of symmetry (12);
wherein said sage leaf profile (15) with a ratio [maximum spacing (E)/maximum cord (C)] comprised between 0.1 and 0.3, comprises two symmetrical curved shapes (13,14) with respect to said plane of symmetry (12) of the profiled element, each curved shape (13,14) of said two symmetrical curved shapes (13,14) extending between a first front point (16) and a second rear point (17), said first front point and second rear point (16,17) extending along an axis of symmetry (AX) which extends within the plane of symmetry (12),
wherein each curved shape (13,14) of said two symmetrical curved shapes (13,14) of said sage leaf profile is defined substantially by 5 to 10 successive arcs of circles (A1 of circle C1, A2 of circle C2, A3 of circle C3, A4 of circle C4, A5 of circle C5), said successive arc of circles being each characterised by a centre of curvature and a radius of curvature, whereby said successive arcs of circles (A1, A2, A3,A4,A5) are interior tangent two by two with increasing radius of curvature (R1,R2,R3,R4,R5) from a minimum radius of curvature (R1) for a curved part in the vicinity of the first front point (16) and a maximum radius of curvature (R5) for a curved part in the vicinity of the second rear point (17), whereby the arc of circle (A1) of the curved part in the vicinity of the first front point (16) is passing through the first front point (16), has its centre of curvature (CC1) located along said axis of symmetry (AX) of the plane of symmetry (12) and has its radius of curvature corresponding to a first radius of curvature (R1) comprised between 0.2 and 0.3 times the maximum spacing (E) of the sage leaf profile, wherein each curved shape of the said cross-section aerodynamic profile (15) of the profiled element (1,2,23,25) follows substantially at least 95% of a sage leaf profile pattern with two symmetrical curved patterns, each symmetrical curved pattern of said two symmetrical curved patterns being defined by five successive arcs of circles, which are:
a first arc of circle (A1) with a first radius of curvature (R1);
a second arc of circle (A2) with a second radius of curvature (R2) comprised between 1.8 and 2.2 times the first radius of curvature (R1);
a third arc of circle (A3) with a third radius of curvature (R3) comprised between 8.5 and 10.5 times the first radius of curvature (R1);
a fourth arc of circle (A4) with a fourth radius of curvature (R4) comprised between 25 and 30 times the first radius of curvature (R1); and
a fifth arc of circle (A5) with a fifth radius of curvature (R5) comprised between 50 and 70 times the first radius of curvature (R1).

33. The use of claim 32, in which the wheeled vehicle is a bicycle.

34. The use of a wheeled vehicle suitable for moving on earth at a speed of less than 100 km/h in a travel direction on a horizontal plane, while being submitted to at least a wind with a speed between 10 km/h and 80 km/h and with an angle of attack at least comprised between 10° and 170° with respect to the travel direction of the wheeled vehicle,
whereby the wheeled vehicle has at least a frame supporting at least one front wheel (21) and one rear wheel (22), whereby said frame is associated to at least one associated element selected among the group consisting of a seat stay (31), a rear chainstay (29) suitable for supporting the rear wheel (22), a fork (27) suitable for supporting the front wheel (21), a front mudguard (30) adapted to cover at least partially the upper part of the front wheel (21), a rear mudguard (3) adapted to cover at least partially the upper part of the rear wheel (22), and a cap (4),
whereby the said at least one associated element is shaped for generating at least one motor force of between 2N and 10N in the travel direction of the wheeled vehicle by the effect of the wind with the speed between 10 km/h and 80 km/h and with the angle of attack at least comprised between 10° and 170° with respect to the travel direction of the wheeled vehicle,
whereby said at least one associated element is an aerodynamic symmetrical profiled element having a plane of symmetry (12) and a curved front end (10) with at least one leading edge, wherein in position of the profiled element with the plane of symmetry (12) located in a vertical plane with the wheeled vehicle rolling on the horizontal rolling plane, said profiled element (3,4,27,29,30,31) has the curved front end (10), a rear end (11), and on either side of said plane of symmetry (12), a curved outer face (13,14), said curved outer faces (13,14) defining in each cross section plane perpendicular to the plane of symmetry (12) and parallel to said horizontal rolling plane (H), a cross-section aerodynamic profile (15),
whereby at least for a part of the profiled element (3,4,27,29,30,31), the said cross-section aerodynamic profile (15) has at least 90% of a central part of a sage leaf profile with a ratio [maximum spacing (E)/maximum cord (C)] comprised between 0.1 and 0.3, whereby the maximum spacing (E) is measured perpendicular to the plane of symmetry (12), while the maximum cord (C) measured in the plane of symmetry (12);
wherein said sage leaf profile (15) with a ratio [maximum spacing (E)/maximum cord (C)] comprised between 0.1 and 0.3, comprises two symmetrical curved shapes (13 ,14) with respect to said plane of symmetry (12) of the profiled element, each curved shape (13,14) of said two symmetrical curved shapes (13,14) extending between a first front point (16) and a second rear point (17), said first front point and second rear point (16,17) extending along an axis of symmetry (AX) which extends within the plane of symmetry (12),
wherein each curved shape (13,14) of said two symmetrical curved shapes (13,14) of said sage leaf profile is defined substantially by 5 to 10 successive arcs of circles (A1 of circle C1, A2 of circle C2, A3 of circle C3, A4 of circle C4, A5 of circle C5), said successive arcs of circles being each characterised by a centre of curvature and a radius of curvature, whereby said successive arcs of circles (A1, A2, A3,A4,A5) are interior tangent two by two with increasing radius of curvature (R1,R2,R3,R4,R5) from a minimum radius of curvature (R1) for a curved part in the vicinity of the first front point (16) and a maximum radius of curvature (R5) for a curved part in the vicinity of the second rear point (17), whereby the arc of circle (A1) of the curved part in the vicinity of the first front point (16) is passing through the first front point (16), has its centre of curvature (CC1) located along said axis of symmetry (AX) of the plane of symmetry (12) and has its radius of curvature corresponding to a first radius of curvature (R1) comprised between 0.2 and 0.3 times the maximum spacing (E) of the sage leaf profile,
wherein each curved shape of the said cross-section aerodynamic profile (15) of the profiled element (1,2,3,4) follows substantially at least 95% of a sage leaf profile pattern with two symmetrical curved patterns, each symmetrical curved pattern of said two symmetrical curved patterns being defined by five successive arcs of circles, which are:
a first arc of circle (A1) with a first radius of curvature (R1);
a second arc of circle (A2) with a second radius of curvature (R2) comprised between 1.8 and 2.2 times the first radius of curvature (R1);
a third arc of circle (A3) with a third radius of curvature (R3) comprised between 8.5 and 10.5 times the first radius of curvature (R1);
a fourth arc of circle (A4) with a fourth radius of curvature (R4) comprised between 25 and 30 times the first radius of curvature (R1); and
a fifth arc of circle (A5) with a fifth radius of curvature (R5) comprised between 50 and 70 times the first radius of curvature (R1).

35. The use of claim 34, in which the wheeled vehicle is a bicycle.
